(19) United States
(12) Patent Application Publication
(10) Pub. No.: US 2011/0161250 A1
(43) Pub. Date: Jun. 30, 2011

(54) DISTRIBUTED ENERGY GENERATOR MONITOR AND METHOD OF USE

(76) Inventors: Adam R. Koeppel, Washington, DC (US); Stuart R. Andrews, Rockville, MD (US); Andrew Jackson, Washington, DC (US); Zach Axelrod, Washington, DC (US); Aaron Block, Washington, DC (US); Kate Heidinger, Washington, DC (US); Michael Healy, Arlington, VA (US)

(21) Appl. No.: 12/773,268

(22) Filed: May 4, 2010

Related U.S. Application Data
(60) Provisional application No. 61/291,676, filed on Dec. 31, 2009.

(51) Int. Cl. G06Q 40/00; G06Q 50/00

(52) U.S. Cl. 705/412; 705/34

(57) ABSTRACT

A computerized method and system for monitoring at least one distributed energy generator, comprising: receiving utility bill information related to an existing utility of a customer, and measured energy information from the distributed energy generator of the customer; and generating a bill for measured energy from the distributed energy generator, the bill taking into account the utility bill information related to the existing utility.

This application claims priority to U.S. Provisional Application 61/291,676, filed on Dec. 31, 2009, and entitled “Distributed Energy Generator Monitor and Method of Use”. The entire contents of this provisional application are herein incorporated by reference.

### BRIEF DESCRIPTION OF THE FIGURES

FIG. 1 is one embodiment of a system 100 for billing a customer for the output of a distributed energy generator at a discount compared to the customer's existing utility rates, according to one embodiment of the invention.

FIGS. 2-5 provide examples of various operations that can be used to bill a customer for the output of a distributed energy generator at a discount compared to the customer's existing utility rates, according to embodiments of the invention.

FIGS. 7-9 provide examples of various distributed energy generators, according to embodiments of the invention.

FIGS. 12-19 provide examples of a various features and subsystems for acquiring and normalizing disparate utility bills necessary for billing a customer for the output of a distributed energy generator at a discount compared to the customer's existing utility rates, according to multiple embodiments.

FIGS. 10-11 and 20 provide examples of a subsystem for capturing and processing normalized utility bill data to compute the value of the output of a distributed energy generator in the context of the utility bill, according to multiple embodiments.

FIGS. 6A-6B provide example of various bills, according to multiple embodiments.

### DETAILED DESCRIPTION OF EMBODIMENTS OF THE INVENTION

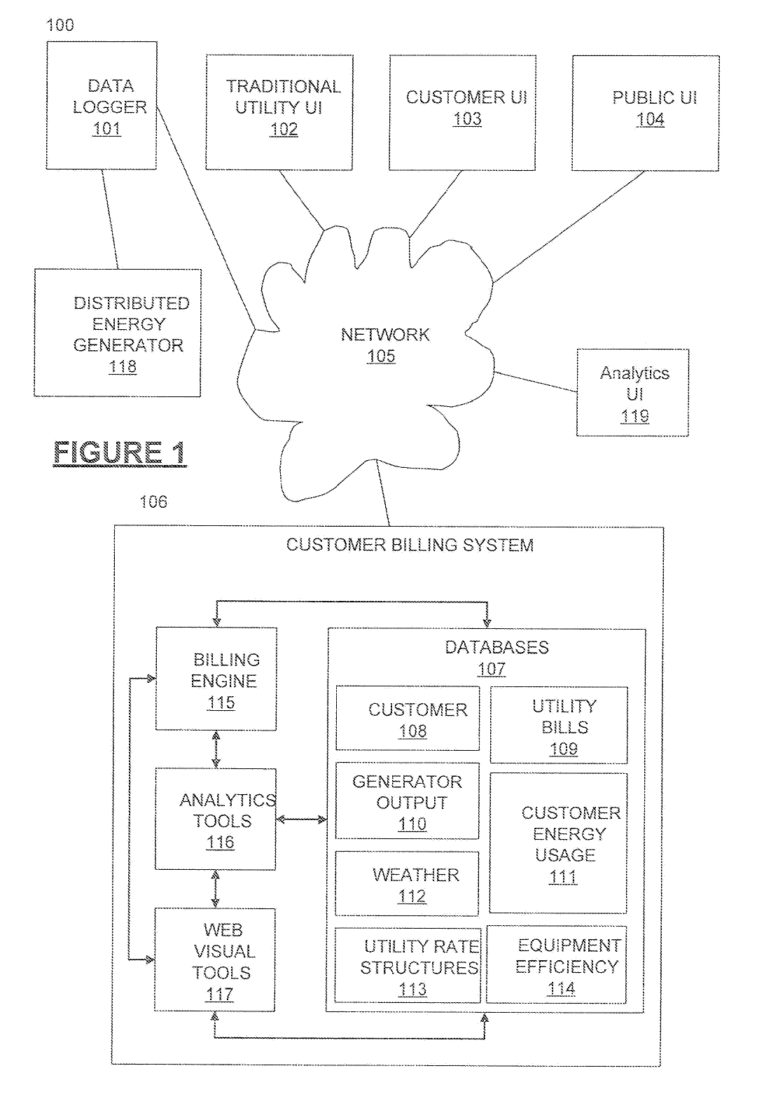

FIG. 1 is one embodiment of a system 100 for billing a customer for the output of a distributed energy generator 118 at a discount compared to the customer's existing utility rates. The system can include a data logger 101, access to the customer's existing utility online billing system 102, a customer user interface 103, a public user interface 104, and a customer billing system 106, all connected by a network, 105. A distributed energy generator 118 comprises power generation technology which can be used to provide an alternative to or an enhancement of the traditional electric power system or natural gas distribution system. In one embodiment, the energy generated by the distributed energy generator 118 and sold to the customer is logged and time stamped by the data logger 101, compared to the customer's traditional utility rate schedule and utility energy usage, and the customer can then be charged for the energy according to a utility rate schedule. For example, the customer's traditional utility rate schedule can be used. However, those of ordinary skill in the art will see that any applicable energy rate schedule can be set. In some embodiments, at least one pre-set discount rate can be applied to the bill.

The system 100 can bill a customer for the output of a distributed energy generator 118 including a solar water heater, solar air heater, solar air chiller, solar electric system, fuel cell system, or ay other type of distributed energy generator.

Any entity (e.g., private entity, utility, or government entity) can buy a distributed energy generator 118 for use by a customer and own and/or operate this system 100 to bill the customer for the energy produced by the distributed energy generator 118. The private entity, utility or government entity can pay for all or part of the capital cost of the distributed energy generator, the installation cost, and the ongoing maintenance cost of the distributed energy generator. The customer can be billed for the energy produced by the distributed energy generator 118, while accounting for the customer's existing utility rate schedule, as tracked, analyzed and computed by the system 100.

For example, suppose a utility company bought several distributed energy generators 118 to own and/or operate for several customers. Suppose a customer uses the existing utility along with the distributed energy generator 118. If the utility company determined that the existing utility cost a particular customer $100 of energy per month, and the energy provided by the distributed energy generator 118 would have cost the customer $50 per month if the customer had bought the same amount of energy from the existing utility, it can be determined that the customer is receiving $150 worth of energy, paying only $100 to their existing utility company, and thus receiving a $50 benefit. The entity providing the distributed energy generator 118 can thus contract with the customer to receive funds that account for the $50 benefit to offset the cost of providing the distributed energy generator 118, and in some embodiments, allow the entity to make a profit over the long-term. In some cases, the benefit received by the customer (e.g., $50) can be equal to the cost charged by the entity providing the distributed energy generator 118 (e.g., $50). In some cases, the benefit received by the customer (e.g., $50) can be somewhat higher than the cost charged by the entity providing the distributed energy generator 118 (e.g., $45). This can provide a monetary incentive for customers to use the distributed energy generator 118. In some cases, the benefit received by the customer (e.g., $50) can be somewhat lower than the cost charged by the entity providing the distributed energy generator 118 (e.g., $55). This model may be attractive, for example, to customers who wish to use green technology in order to help the environment.

It should be noted that in the above embodiment, the customer can install the distributed energy generator 118 without making a capital investment and/or the customer can receive value immediately after installation of the distributed energy generator 118. In addition, the customer can receive the benefits of the at least one distributed energy generator 118 without risking maintenance costs and/or the distributed energy production being below predicted output. Furthermore, the customer billing system 106 can be set up so that for any point in time, the customer does not pay more for energy from the at least one distributed energy generator 118 than the customer would have paid for equivalent energy purchased from the customer's existing utility.

In addition, the customer can receive value from renewable energy credits delivered by the at least one distributed energy generator 118 regardless of the at least one customer's size and/or understanding of the renewable energy credit market. Furthermore, the customer can gain a better understanding of how the distributed energy generator 118 impacts energy costs because information on energy use of the distributed energy generator 118 and the customer's existing utility can be provided.

Additionally, information can be provided (e.g., to the customer billing system 106, to a third party) that can be used to sharpen pricing formulas and product and system performance forecasts. In addition, small non-qualifying distributed energy generators 118 can be operated on a larger scale to qualify for benefits. Such benefits can include, but are not limited to: tax-related benefits; clean energy program benefits; aggregation of Renewable Energy Credits or Solar Renewable Energy Credits; or any combination thereof.

The data logger 101 can be used to send data to the customer billing system 106 which will be used to bill the customer for the output of the distributed energy generator 118.

The traditional utility user interface 102 can be used by the customer billing, system 106 to download a customer's traditional utility bills.

The customer user interface 103 can be used by customers to communicate with the customer billing system 106.

The public user interface 104 can be used by members of the public to view data from the customer billing system 106 on distributed energy generator 118 production, carbon emissions reduced, and energy cost savings delivered to customers.

The analytics user interface 119 can be used by system operators to monitor the performance of distributed energy generators 118 for comparing performance of different distributed energy generator technologies, monitoring distributed energy generator performance degradation for maintenance purposes, monitoring customers' usage of distributed energy generators 118 for system sizing and capital deployment optimization purposes, and other analytical purposes.

Within the customer billing system 106, databases 107 can contain customer data 108, customer utility bills 109 downloaded from traditional utility user interfaces 102, distributed energy generator 118 production data 110, energy produced by the distributed energy generator 118 and sold to the customer data 111, distributed energy generator 118 location weather data 112, customer's rate structures from the customer's traditional utility 113, and customer equipment efficiency data 114.

The data within these databases 107 can be processed and analyzed by the billing engine 115 which can compare the energy from the distributed energy generator 118 sold to the customer 111 and the customer's traditional utility rate structure data 113 to generate a bill for the customer which charges the customer for the output of the distributed energy generator 118 according to the customer's traditional utility's existing rate structure. (It should be noted that the utility rate structure can include all taxes, tariffs, environmental charges, and other charges that are a function of energy consumed.)

The data within these databases 107 can also be processed and analyzed by the analytics tools 116 which can automatically monitor the performance of distributed energy generators 118 for comparing performance of different distributed energy generator technologies, monitoring distributed energy generator performance degradation for maintenance purposes, monitoring customers' usage of distributed energy generators for system sizing and capital deployment optimization purposes, and flagging data for system operator review when values exceed thresholds set by the system operators. The data can also be processed and analyzed for presentation to system operators over the analytics user interface 119.

In addition, the data within these databases 107 can be processed by the web visual tools 117 to prepare graphics and tables of data for presentation to customers over the customer user interface 103.

The data within these databases 107 can additionally be processed by the web visual tools 117 to prepare graphics and tables of data for presentation to the public over the public user interface 104.

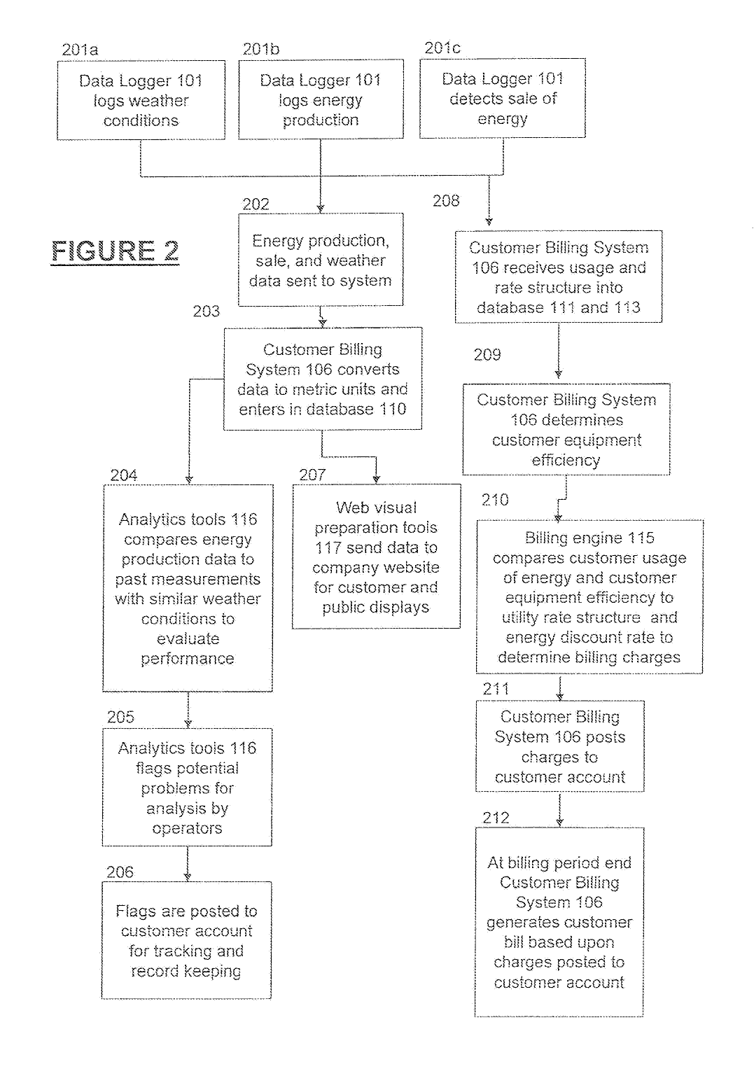

FIG. 2 illustrates a method for billing a customer for the output of a distributed energy generator 118, according to one embodiment. In 201c, the data logger can detect the sale of energy from the distributed energy generator 118 to the customer. For example, the data logger could detect the output of five pulses from a pulse energy meter from 1:15 PM to 1:16 PM on a Monday. The data logger can also log the energy production 201b of the distributed energy generator 118, and the weather conditions 201a at the location of the distributed energy generator 118 during this minute. For example, the data logger could log the average solar irradiance during this minute as an insolation sensor output of 1.2V and the weather conditions as an outdoor temperature sensor resistance of 9.1 k Ohm.

In 202, the energy production, sale, and weather data can be sent to the customer billing system 106. For example, the five pulses counted by the pulse energy meter, the 9.1 k Ohm temperature sensor reading, and the insolation sensor output of 1.2V can be combined into one data packet and transmitted to the customer billing system.

In 203, the customer billing system 106 can enter the data into the databases 107 and can convert the data from analog data to metric data. For example, the five pulses counted by the pulse energy meter can be entered into the databases 107, and an additional entry can be made converting these five pulses into a corresponding energy usage of 1 kilowatt-hour. The 9.1 k Ohm temperature sensor reading can be entered into the databases 107 and an additional entry can be made converting this temperature sensor reading into a temperature of 0.83 degrees centigrade. The 1.2V insolation sensor reading can be entered into the databases 107 and an additional entry can be made converting this insolation sensor reading into an irradiance of 719 watts per meter squared of solar irradiance.

In 204, the analytics tools 116 can compare energy production data from the distributed energy generator 118 to past measurements from the same distributed energy generator 118 with similar weather conditions to evaluate performance of the distributed energy generator 118. For example, the analytics tools 116 can search for a previous entry in the databases 107 for a minute of energy production corresponding to an outdoor temperature of 0.83 degrees centigrade, and a solar irradiance of 719 watts per meter squared. The analytics tools 116 can then compare the current energy output of 1 kilowatt-hour during the new reading to the energy output of the corresponding previous entry in the database. If the corresponding previous energy output database entry is lower than 1 kilowatt-hour, this indicates that distributed energy generator 118 performance has improved. If the corresponding previous energy output database entry is higher, this indicates that distributed energy generator 118 performance has declined. If no previous entry in the database is an exact match, the analytical tools 116 can search for the closest previous entry.

For example, the analytical tools 116 may search for a previous entry with a solar irradiance ranging from 701 watts per meter squared to 737 watts per meter squared, equivalent to the solar irradiance reading plus or minus 2.5%, or some other specified margin, and an outdoor temperature of 0.80 degrees centigrade to 0.86 degrees centigrade, equivalent to the temperature sensor reading plus or minus 2.5% or some other specified margin. The analytical tools 116 may have the comparison margin dynamically reconfigured by the system operator or may select a margin that corresponds to a set sample size chosen by the system operator or may select a margin that guarantees a sample size corresponding to a low sampling error. The analytical tools 116 may also compare the new reading of 1 kilowatt-hour generated during this minute to an average per minute output of previous entries with a solar irradiance of 719 watts per meter squared, and an outdoor temperature of 0.83 degrees centigrade. Alternatively, if insufficient previous entries with exactly matched weather data exist, the analytical tools 116 may instead compare the new reading of 1 kilowatt-hour generated during this minute to an average per minute output of similar previous entries with a solar irradiance ranging from 701 watts per meter squared to 737 watts per meter squared, equivalent to the solar irradiance reading plus or minus 2.5%, or some other specified margin, and an outdoor temperature of 0.80 degrees centigrade to 0.86 degrees centigrade, equivalent to the temperature sensor reading plus or minus 2.5% or some other specified margin, to determine performance changes.

The analytical tools 116 may also track long term trends, by comparing exactly matched or closely matched days over longer periods of time to determine if system performance is trending upwards or downwards. For example, given the new reading of 1 kilowatt-hour generated during a minute with a solar irradiance of 719 watts, and an outdoor temperature of 0.83 degrees centigrade, the analytical tools 116 may search for previous entries with a solar irradiance of 719 watts per meter squared and an outdoor temperature of 0.83 degrees centigrade days, weeks, months or years apart. By tracking the long term trends in these corresponding entries, the analytical tools 116 can determine the long term rate of change of system performance.

Alternatively, if insufficient previous entries with exactly matched weather data exist, the analytical tools 116 may instead compare the new reading of 1 kilowatt-hour generated during this minute to or an average per minute output of similar previous entries with a solar irradiance ranging from 701 watts per meter squared to 737 watts per meter squared, equivalent to the solar irradiance reading plus or minus 2.5%, or some other specified margin, and an outdoor temperature of 0.80 degrees centigrade to 0.86 degrees centigrade, equivalent to the temperature sensor reading plus or minus 2.5% or some other specified margin days, weeks, months or years apart. By tracking the long term trends in these corresponding entries, the analytical tools 116 can determine the long term rate of change of system performance.

In addition to comparing an individual distributed energy generator 118 to itself, the analytical tools 116 can perform all of the above comparisons on different distributed energy generators 118 to compare and contrast performance. For example, given distributed energy generator 118 at location A producing 1 kilowatt-hour from 1:15 PM to 1:16 PM on a Monday with an average solar irradiance of 719 watts per meter squared and an average outdoor temperature of 0.83 degrees centigrade during this minute, the analytics tools 116 can search for a previous entry in the databases 107 for a minute of energy production from a different distributed energy generator 118 at location B corresponding to an outdoor temperature of 0.83 degrees centigrade, and a solar irradiance of 719 watts per meter squared. The analytics tools 116 can then compare the energy output of 1 kilowatt-hour from the distributed energy generator 118 at location A to the energy output of the distributed energy generator 118 at location B. If the corresponding previous energy output database entry is lower than 1 kilowatt-hour, this indicates that distributed energy generator 118 at location A is outperforming the distributed energy generator at location B. If the corresponding previous energy output database entry is higher, this indicates that distributed energy generator 118 at location B is outperforming the distributed energy generator 118 at location A.

If no previous entry in the database is an exact match, the analytical tools 116 can search for the closest previous entry. For example, the analytical tools 116 may search for a previous entry for distributed energy generator 118 at location B with a solar irradiance ranging from 701 watts per meter squared to 737 watts per meter squared, equivalent to the solar irradiance reading plus or minus 2.5%, or some other specified margin, and an outdoor temperature of 0.80 degrees centigrade to 0.86 degrees centigrade, equivalent to the temperature sensor reading plus or minus 2.5% or some other specified margin. The analytical tools 116 may have the comparison margin dynamically reconfigured by the system operator or may select a margin that corresponds to a set sample size chosen by the system operator or may select a margin that guarantees a sample size corresponding to a low sampling error. The analytical tools 116 may also compare the new reading of 1 kilowatt-hour generated during this minute by the distributed energy generator at location A to an average per minute output of previous entries with a solar irradiance of 719 watts per meter squared, and an outdoor temperature of 0.83 degrees centigrade from the distributed energy generator at location B. Alternatively, if insufficient previous entries with exactly matched weather data exist, the analytical tools 116 may instead compare the new reading of 1 kilowatt-hour generated during this minute by the distributed energy generator 118 at location A to or an average per minute output of similar previous entries with a solar irradiance ranging from 701 watts per meter squared to 737 watts per meter squared, equivalent to the solar irradiance reading plus or minus 2.5%, or some other specified margin, and an outdoor temperature of 0.80 degrees centigrade to 0.86 degrees centigrade, equivalent to the temperature sensor reading plus or minus 2.5% or some other specified margin, from the distributed energy generator 118 at location B.

The analytical tools 116 may also track long term trends, by comparing exactly matched or closely matched days over longer periods of time to determine if system performance is trending upwards or downwards. For example, given the new reading of 1 kilowatt-hour generated by the distributed energy generator 118 at location A during a minute with a solar irradiance of 719 watts, and an outdoor temperature of 0.83 degrees centigrade, the analytical tools 116 may search for previous entries with a solar irradiance of 719 watts per meter squared and an outdoor temperature of 0.83 degrees centigrade from the distributed energy generator at location B days, weeks, months or years apart. By tracking the long term trends in these corresponding entries, the analytical tools 116 can compare the long term performance of the distributed energy generator 118 at location A and the distributed energy generator 118 at location B. Alternatively, if insufficient previous entries with exactly matched weather data exist, the analytical tools 116 may instead compare the new reading of 1 kilowatt-hour generated during this minute from the distributed energy generator 118 at location A to or an average per minute output of similar previous entries with a solar irradiance ranging from 701 watts per meter squared to 737 watts per meter squared, equivalent to the solar irradiance reading plus or minus 2.5%, or some other specified margin, and an outdoor temperature of 0.80 degrees centigrade to 0.86 degrees centigrade, equivalent to the temperature sensor reading plus or minus 2.5% or some other specified margin from the distributed energy generator 118 at location B days, weeks, months or years apart. By tracking the long term trends in these corresponding entries, the analytical tools 116 can compare the long term performance of the distributed energy generator 118 at location A and the distributed energy generator 118 at location B. The analytical tools can also use data on technology, installation technique or other differences between the distributed energy generator 118 at location A and the distributed energy generator 118 at location B and the above techniques of comparison to evaluate the performance of different distributed energy generator 118 technologies, installation techniques or other relevant differences.

In addition to comparing an individual distributed energy generator 118 to another distributed energy generator 118, the analytical tools 116 can perform all of the above comparisons on an individual distributed energy generator 118 matched with an average of a group of different distributed energy generators 118 to compare and contrast performance. For example, given distributed energy generator 118 at location A producing 1 kilowatt-hour from 1:15 PM to 1:16 PM on a Monday with an average solar irradiance of 719 watts per meter squared and an average outdoor temperature of 0.83 degrees centigrade during this minute, the analytics tools 116 can search for previous entry in the databases 107 for a minute of energy production from several different distributed energy generators 118 at locations B, C and D corresponding to an outdoor temperature of 0.83 degrees centigrade, and a solar irradiance of 719 watts per meter squared. The analytics tools 116 can then compare the energy output of 1 kilowatt-hour from the distributed energy generator 118 at location A to the average energy output of the distributed energy generators 118 at locations B, C and D.

If the average of the corresponding previous energy output database entries for the distributed energy generators 118 at locations B, C and D is lower than 1 kilowatt-hour, this indicates that distributed energy generator 118 at location A is outperforming the distributed energy generators at locations B, C and D. If the average of the corresponding previous energy output database entries for the distributed energy generators 118 at locations B, C and D is higher, this indicates that distributed energy generators 118 at locations B, C and D are outperforming the distributed energy generator 118 at location A. If no previous entry in the database is an exact match, the analytical tools 116 can search for the closest previous entry. For example, the analytical tools 116 may search for previous entries for distributed energy generators 118 at locations B, C and D with a solar irradiance ranging from 701 watts per meter squared to 737 watts per meter squared, equivalent to the solar irradiance reading plus or minus 2.5%, or some other specified margin, and an outdoor temperature of 0.80 degrees centigrade to 0.86 degrees centigrade, equivalent to the temperature sensor reading plus or minus 2.5% or some other specified margin. The analytical tools 116 may have the comparison margin dynamically reconfigured by the system operator or may select a margin that corresponds to a set sample size chosen by the system operator or may select a margin that guarantees a sample size corresponding to a low sampling error. The analytical tools 116 may also compare the new reading of 1 kilowatt-hour generated during this minute by the distributed energy generator at location A to an average per minute output of previous entries with a solar irradiance of 719 watts per meter squared, and an outdoor temperature of 0.83 degrees centigrade from the distributed energy generators 118 at locations B, C and D. Alternatively, if insufficient previous entries with exactly matched weather data exist, the analytical tools 116 may instead compare the new reading of 1 kilowatt-hour generated during this minute by the distributed energy generator 118 at location A to or an average per minute output of similar previous entries with a solar irradiance ranging from 701 watts per meter squared to 737 watts per meter squared, equivalent to the solar irradiance reading plus or minus 2.5%, or some other specified margin, and an outdoor temperature of 0.80 degrees centigrade to 0.86 degrees centigrade, equivalent to the temperature sensor reading plus or minus 2.5% or some other specified margin, from the distributed energy generators 118 at locations B, C and D.

The analytical tools 116 may also track long term trends, by comparing exactly matched or closely matched days over longer periods of time to determine if system performance is trending upwards or downwards. For example, given the new reading of 1 kilowatt-hour generated by the distributed energy generator 118 at location A during a minute with a solar irradiance of 719 watts, and an outdoor temperature of 0.83 degrees centigrade, the analytical tools 116 may search for previous entries with a solar irradiance of 719 watts per meter squared and an outdoor temperature of 0.83 degrees centigrade from the distributed energy generators at locations B, C and D days, weeks, months or years apart. By tracking the long term trends in these corresponding entries, the analytical tools 116 can compare the long term performance of the distributed energy generator 118 at location A and the distributed energy generators 118 at locations B, C and D.

Alternatively, if insufficient previous entries with exactly matched weather data exist, the analytical tools 116 may instead compare the new reading of 1 kilowatt-hour generated during this minute from the distributed energy generator 118 at location A to or an average per minute output of similar previous entries with a solar irradiance ranging from 701 watts per meter squared to 737 watts per meter squared, equivalent to the solar irradiance reading plus or minus 2.5%, or some other specified margin, and an outdoor temperature of 0.80 degrees centigrade to 0.86 degrees centigrade, equivalent to the temperature sensor reading plus or minus 2.5% or some other specified margin from the distributed energy generators 118 at locations B, C and D days, weeks, months or years apart.

By tracking the long term trends in these corresponding entries, the analytical tools 116 can compare the long term performance of the distributed energy generator 118 at location A and the distributed energy generators 118 at locations B, C and D. The analytical tools can also use data on technology, installation technique or other differences between the distributed energy generator 118 at location A and the distributed energy generators 118 at locations B, C and D and the above techniques of comparison to evaluate the performance of different distributed energy generator 118 technologies, installation techniques or other relevant differences.

In addition to comparing an individual distributed energy generator 118 to a group of distributed energy generators 118, the analytical tools 116 can perform all of the above comparisons on two different groups of distributed energy generators 118 to compare and contrast performance. For example, given distributed energy generators 118 at locations A, B and C producing an average of 1 kilowatt-hour from 1:15 PM to 1:16 PM on a Monday with an average solar irradiance of 719 watts per meter squared and an average outdoor temperature of 0.83 degrees centigrade during this minute, the analytics tools 116 can search for previous entries in the databases 107 for a minute of energy production from several different distributed energy generators 118 at locations D, E and F corresponding to an average outdoor temperature of 0.83 degrees centigrade, and an average solar irradiance of 719 watts per meter squared. The analytics tools 116 can then compare the average energy output of 1 kilowatt-hour from the distributed energy generators 118 at locations A, B and C to the average energy output of the distributed energy generators 118 at locations D, E and F. If the average of the corresponding previous energy output database entries for the distributed energy generators 118 at locations D, E and F is lower than 1 kilowatt-hour, this indicates that distributed energy generators 118 at locations A, B and C are outperforming the distributed energy generators at locations D, E and F. If the average of the corresponding previous energy output database entries for the distributed energy generators 118 at locations D, E and F is higher, this indicates that distributed energy generators 118 at locations D, E and F are outperforming the distributed energy generator 118 at location A, B and C. If no previous entries in the database are an exact match, the analytical tools 116 can search for the closest previous entries.

For example, the analytical tools 116 may search for previous entries for distributed energy generators 118 at locations D, E and F with a solar irradiance ranging from 701 watts per meter squared to 737 watts per meter squared, equivalent to the solar irradiance reading plus or minus 2.5%, or some other specified margin, and an outdoor temperature of 0.80 degrees centigrade to 0.86 degrees centigrade, equivalent to the temperature sensor reading plus or minus 2.5% or some other specified margin. The analytical tools 116 may have the comparison margin dynamically reconfigured by the system operator or may select a margin that corresponds to a set sample size chosen by the system operator or may select a margin that guarantees a sample size corresponding to a low sampling error. The analytical tools 116 may also compare the new average reading of 1 kilowatt-hour generated during this minute by the distributed energy generator at locations A, B and C to an average per minute output of previous entries with a solar irradiance of 719 watts per meter squared, and an outdoor temperature of 0.83 degrees centigrade from the distributed energy generators 118 at locations D, E and F.

Alternatively, if insufficient previous entries with exactly matched weather data exist, the analytical tools 116 may instead compare the new average reading of 1 kilowatt-hour generated during this minute by the distributed energy generator 118 at locations Am B and C to or an average per minute output of similar previous entries with a solar irradiance ranging from 701 watts per meter squared to 737 watts per meter squared, equivalent to the solar irradiance reading plus or minus 2.5%, or some other specified margin, and an outdoor temperature of 0.80 degrees centigrade to 0.86 degrees centigrade, equivalent to the temperature sensor reading plus or minus 2.5% or some other specified margin, from the distributed energy generators 118 at locations D, E and F.

The analytical tools 116 may also track long term trends, by comparing exactly matched or closely matched days over longer periods of time to determine if system performance is trending upwards or downwards. For example, given the new average reading of 1 kilowatt-hour generated by the distributed energy generator 118 at locations A, B and C during a minute with a solar irradiance of 719 watts, and an outdoor temperature of 0.83 degrees centigrade, the analytical tools 116 may search for previous entries with a solar irradiance of 719 watts per meter squared and an outdoor temperature of 0.83 degrees centigrade from the distributed energy generators at locations D, E and F days, weeks, months or years apart. By tracking the long term trends in these corresponding entries, the analytical tools 116 can compare the long term performance of the distributed energy generators 118 at locations A, B and C and the distributed energy generators 118 at locations D, E and F.

Alternatively, if insufficient previous entries with exactly matched weather data exist, the analytical tools 116 may instead compare the new average reading of 1 kilowatt-hour generated during this minute from the distributed energy generators 118 at locations A, B and C to or an average per minute output of similar previous entries with a solar irradiance ranging from 701 watts per meter squared to 737 watts per meter squared, equivalent to the solar irradiance reading plus or minus 2.5%, or some other specified margin, and an outdoor temperature of 0.80 degrees centigrade to 0.86 degrees centigrade, equivalent to the temperature sensor reading plus or minus 2.5% or some other specified margin from the distributed energy generators 118 at locations D, E and F days, weeks, months or years apart. By tracking the long term trends in these corresponding entries, the analytical tools 116 can compare the long term performance of the distributed energy generators 118 at locations A, B and C and the distributed energy generators 118 at locations D, E and F.

The analytical tools can also use data on technology, installation technique or other differences between the distributed energy generators 118 at locations A, B and C and the distributed energy generators 118 at locations D, F and F and the above techniques of comparison to evaluate the performance of different distributed energy generator 118 technologies, installation techniques or other relevant differences.

In 205, the analytics tools 116 can flag potential problems for analysis by system operators. Flags may include, but are not limited to, a distributed energy generator 118 with a long term trend of performance declines, a distributed energy generator 118 with long term performance increases, a distributed energy generator 118 with low performance compared to similar distributed energy generators 118, a distributed energy generator 118 with high performance compared to similar distributed energy generators 118, a distributed energy generator 118 that is non operational, a distributed energy generator 118 that is operating in a non-typical manner, or a data logger 101 that is no longer communicating with the customer billing system 106. In 206, flags can be posted to the customer's account for tracking and record keeping. For example, if the comparison of 1 kilowatt-hour of energy generated given an outdoor temperature of 0.83 degrees centigrade, and 719 watts per meter squared of solar irradiance is below the corresponding previous energy output database entry, a flag of declining distributed energy generator 118 performance may be added to the customer's account.

In 207, web visual tools 117 can send data to be displayed (e.g., on a company website for customers, on a community website, on a government website). For example, the web visual tools can add the 1 kilowatt-hour of energy production to an energy production graph on a company website, while converting this 1 kilowatt-hour of energy production to an equivalent reduction of 0.612 kilograms of carbon emissions and sending this to a carbon emissions reduction graph on the company website. Note that those of ordinary skill in the art will understand how to convert energy production to an equivalent reduction of carbon emissions.

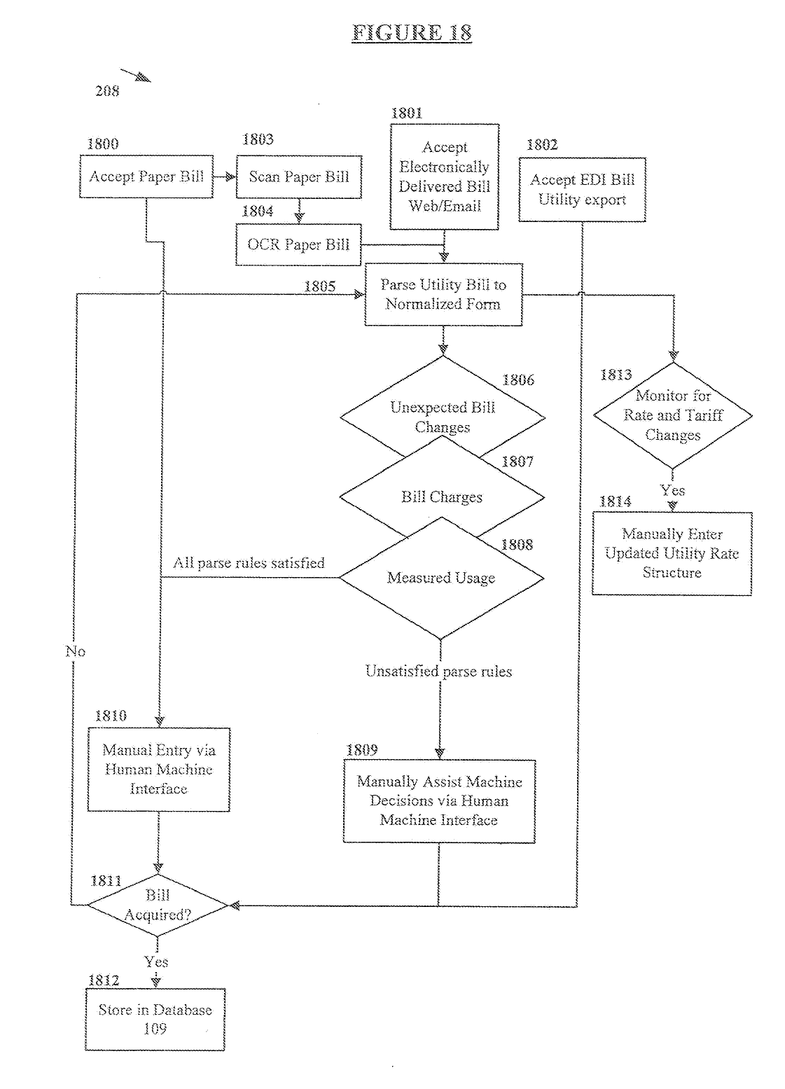

In 208, the customer billing system 106′ can receive customer energy usage and rate structure information extracted from the customer's traditional utility bill into databases 111 and 113. (Additional details related to 208 are explained below with respect to FIG. 18.)

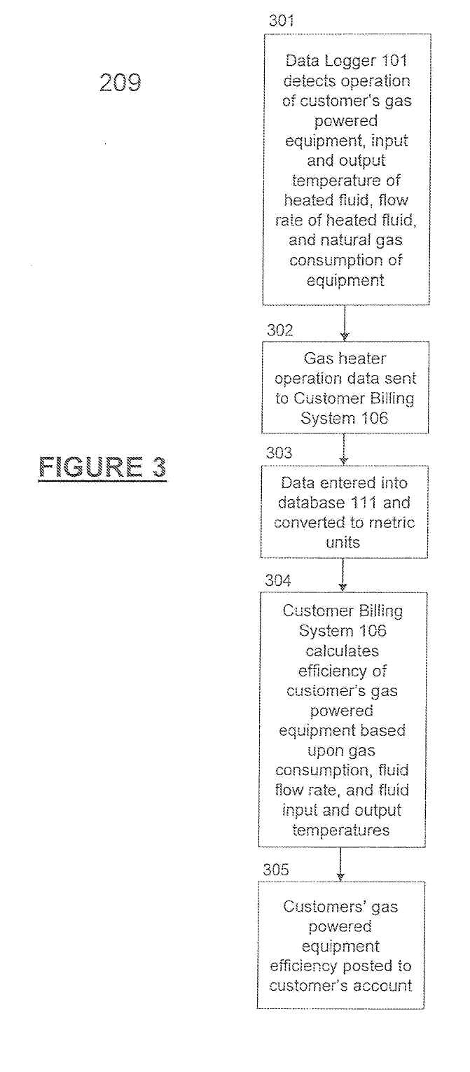

In 209, in some embodiments, the customer equipment efficiency can be determined. (Additional details related to 209 are explained below with respect to FIG. 3.) In some embodiments, the customer equipment efficiency can be aggregated with respect to billing. For example, when fossil fuels (e.g., propane, gas, oil, coal, exotic fuels) are used, the equipment efficiency can be less than 100%. Thus, for example, if a customer has a gas heater with a 92% efficiency, and the customer then installs the distributed energy generator 118 with alternative energy sources, for any use of the gas heater that is replaced by an alternative energy source (e.g., electric, wind, water, solar) with a higher equipment efficiency, the customer should get credit for the fact that the alternative energy source has 100% efficiency instead of just 92% efficiency. It should be noted that, in other embodiments, such as when electric, wind, or water equipment is used, the equipment efficiency can be at or close to 100%, so the customer equipment efficiency does not need to be determined.

In 210, the customer billing system 106 can compare the customer usage of energy (from 209) from the distributed energy generator 118 to the customer's utility rate structure, the customer's equipment efficiency and the customer's energy discount rate to determine billing charges for energy produced by the distributed energy generator 118 and used by the customer. For example, the customer billing system can compare the customer's usage of 1 kilowatt-hour from the distributed energy generator at 1:15 PM on a Monday to the customer's utility rate structure, and determine that this is on-peak usage of energy by the customer and should correspond to an energy price of $0.20 per kilowatt-hour. The customer billing system can then consider that the 1 kilowatt-hour of energy sold to the customer offsets 1.25 kilowatt-hours of utility purchased energy due to the 80% efficiency of the customer's existing equipment. Thus, the actual charge for equivalent utility energy is $0.25 because the 1 kilowatt-hour of energy sold to the customer from the distributed energy generator 118, divided by the 80% efficiency of the customer's existing equipment is equivalent to the customer purchasing 1.25 kilowatt-hours of energy from the utility, for a total price of $0.25. The customer billing system can then compare the $0.25 charge for equivalent utility energy to a pre-set energy discount rate of 15% and determine that the customer should be charged $0.21 for the 1 kilowatt-hour of energy purchased at 1:15 PM on a Monday from the distributed energy generator 118.

In 211, the customer billing system 106 can post calculated charges for energy used by the customer and generated by the distributed energy generator 118 to the customer's account. For example, the $0.21 of energy purchased form the distributed energy generator 118 is posted to the customer's account, and added to the total energy purchased by the customer from the distributed energy generator 118 during the current billing period. In 212, the customer billing system 106 can generate a bill for the customer based upon the charges posted to the customer's account. In one embodiment, more than one utility service can be combined in the bill. For example, the customer billing system, at the conclusion of the billing period, can take a total energy purchase during the billing period of $250 and generate a bill for the customer including a breakdown of how many kilowatt-hours this represents, and how this energy purchased reflects on-peak and off-peak pricing from the customer's existing utility, and how much money the customer saved by purchasing energy from the distributed energy generator instead of the existing utility.

It should be noted that, in some embodiments, the above billing information for many customers can be gathered and utilized. For example, efficiency and cost information relating to distributed energy generator products and installation can be used to determine which distributed energy generator products (e.g., water energy versus solar energy, one manufacturer over another) to use in the future.

As indicated above in 208 of FIG. 2, FIG. 18 illustrates details related to a method for gathering normalized data related to customer energy usage and rate structure from utility hills. FIG. 18 illustrates four embodiments: using manual entry of data (1810), using optical character recognition of data after scanning in data (1803), using web page scraping (1801), and using electronic document interchange (1802). This information can be from diverse sources and can be verified for accuracy prior to being entered into the customer billing system database.

Referring to the first embodiment of FIG. 18, in 1810, the system operator can manually enter data from a customer's existing utility bill (e.g., a paper bill from 1800) into the customer billing system database.

Referring to the second embodiment of FIG. 18, in 1804, the customer billing system 106 can use optical character recognition (OCR) to scan in a paper bill (e.g., from 1800) or a fixed layout electronic bill from the customer's existing utility. In 1805-1808 the data from the optical character recognition scan can be parsed and examined for probable errors which can be flagged for system operator review. In 1809 the system operator can review and correct the probable errors. Those of ordinary skill in the art will see that when referring to the system operator throughout this application, any person or automated function can be used in place of the system operator. In 1811, the bill can be flagged as acquired or not. If acquisition did not complete properly, the system can be re-initialized with accurate information. If the bill is acquired, in 1812 the accurate OCR data and the data corrected by the operator can be combined and then passed on to the customer billing system database 109.

For example, the customer billing system, upon detection of a new fixed layout customer bill available for download from a customer's existing utility website, can scan this bill using optical character recognition, extracting an energy rate of $0.12 per kilowatt-hour from the customer's rate structure. If this rate is consistent with the customer's previous utility bill rate structure data, the customer billing system can enter this rate into the database. If this rate is inconsistent with the customer's previous utility bill rate structure data, the customer billing system can flag the entry for operator review. The operator can then review the rate next to the fixed layout bill, and if necessary correct it prior to entry in the database.

Referring to the third embodiment of FIG. 18, in 1801, the customer billing system can use web page scraping to scan the online bill from the customer's existing utility. In 1805-1808 the data from the web page scrape can be examined for probable errors which are flagged for system operator review. In 1809 the system operator can review and correct the probable errors. In 1811, the bill can be flagged as acquired or not. If acquisition did not complete properly, the system can be re-initialized with accurate information. If the bill is acquired, in 1812, the data which is determined to be accurate and the data corrected by the operator can be combined and then passed on the customer billing system database 109.

For example, the customer billing system, upon detection of new customer bill data posted on a customer's existing utility website, can scan this bill data using optical character recognition, extracting an energy rate of $0.12 per kilowatt-hour from the customer's rate structure. If this rate is consistent with the customer's previous utility bill rate structure data, the customer billing system can enter this rate into the database. If this rate is inconsistent with the customer's previous utility bill rate structure data, the customer billing system can flag the entry for operator review. The operator can then review the rate next to the online billing data, and if necessary correct it prior to entry in the database.

Referring to the fourth embodiment of FIG. 18, in 1802, the customer billing system 106 can draw electronic data from the database of the customer's existing utility, or the customer's existing utility rate structures from the database of a third party, and then can pass on the data to the customer billing system database 109.

It should be noted that during acquisition and normalization it is possible to identify differences between the rate structure of record and what is billed by the utility. During parsing, the stored rate structure 113 can be compared against the normalized bill information to find differences, as illustrated in 1813. If found, in 1814, the system operator can be prompted to intervene.

FIG. 3 illustrates a method for determining the customer equipment efficiency, according to one embodiment (209 in FIG. 2). In the example set forth in FIG. 3, the efficiency of natural gas powered equipment can be determined. Those of ordinary skill in the art will see that the efficiency of many other types of customer equipment can also be determined. Referring to FIG. 3, in 301, the data logger 101 can detect equipment operation data. For example, the input and output temperature of the heated fluid, the flow rate of the fluid, and the natural gas consumption of the equipment can be detected. (Note that those of ordinary skill in the art will see that not all of these measurements need to be taken in some embodiments. In addition, in some embodiments, other measurements can be taken.) For example, during a one minute interval, the data logger 101 on an instantaneous natural gas water heater may log an input temperature sensor reading of 9.1 k Ohms, an output temperature sensor reading of 9.8 k Ohms, a flow sensor pulse count of 20 pulses and natural gas meter pulse count of 10 pulses. In 302, the data logger 101 can send the gas equipment operation data to the system. In 303, the system enters the operation data into the databases 107 and converts the analog measurements data into metric units. For example the input temperature sensor reading of 9.1 k Ohms corresponds to an input temperature of 10 degrees centigrade, the output temperature sensor reading of 9.8 k Ohms corresponds to an output temperature of 80 degrees centigrade, a flow sensor pulse count of 20 pulses corresponds to a flow rate of 10 kilograms, and a gas meter pulse count of 10 pulses corresponds to a gas consumption of 1 kilowatt-hour. In 304, the efficiency tool can calculate the efficiency of the customer's gas powered equipment based upon the gas consumption, fluid flow rate, and fluid input and output temperatures. For example, based upon an input temperature of water of 10 degrees centigrade, an output temperature of water of 80 degrees centigrade, 10 kilograms of water heated during a minute, and natural gas consumption of 1 kilowatt-hour, the efficiency of the instantaneous natural gas powered water heater is 81% because the energy requirement to heat 10 kilograms of water from 10 degrees centigrade to 80 degrees centigrade is 0.81 kilowatt-hours, and the natural gas consumption was 1 kilowatt-hour, yielding a customer gas powered equipment efficiency of 81%. In 305, the calculated efficiency of the customer's gas powered equipment can be posted to the customer's account.

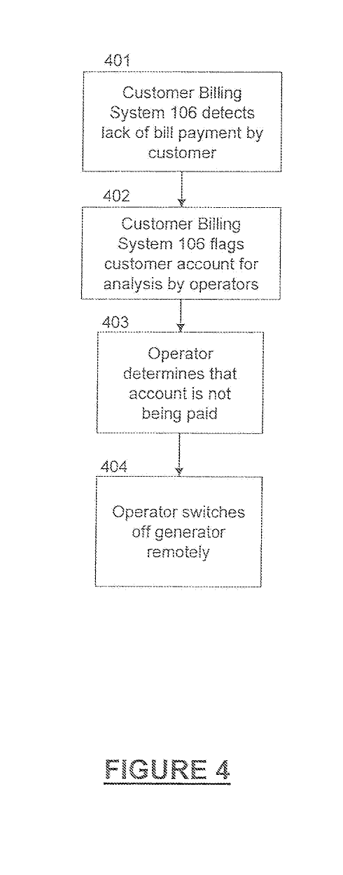

FIG. 4 illustrates a method for terminating distributed energy generator service to a customer based upon lack of payment by the customer for energy used from the distributed energy generator 118, according to one embodiment. In 401, the customer billing system 106 can detect lack of payment by the customer. For example, the customer billing system determines that no payment from the customer has been posted to the customer's account by the due date of the payment. In 402, the customer billing system can flag the customer's account for analysis by system operators based upon lack of payment by the customer for energy from the distributed energy generator 118 used by the customer. In 403, the system operator can review the flagged account and determine that the customer has not made payment for energy from the distributed energy generator 118 used by the customer. In 404, the system operator can switch off the distributed energy generator 118 remotely. For example, the system operator can send a command remotely through the customer billing system to the data logger 101 to turn off the distributed energy generator 118 at the customer's site.

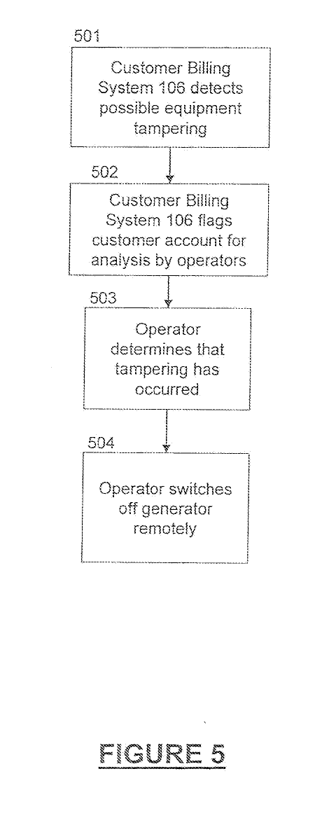

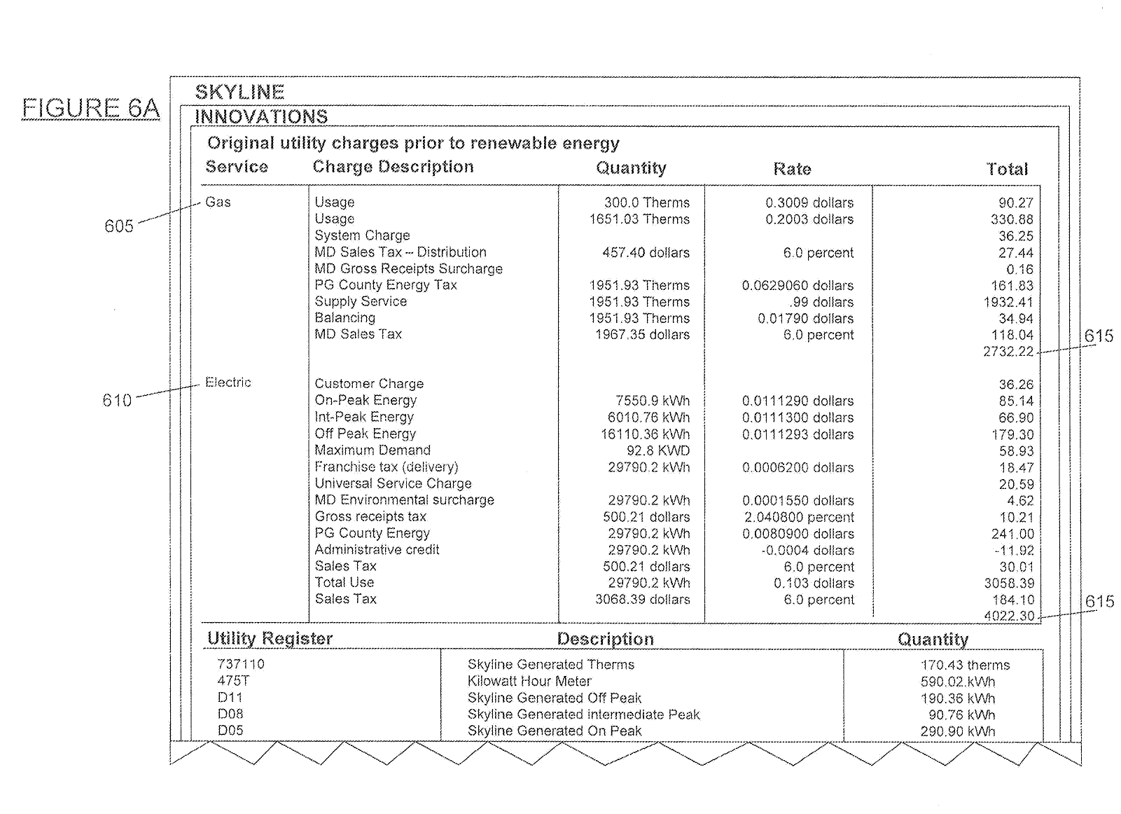

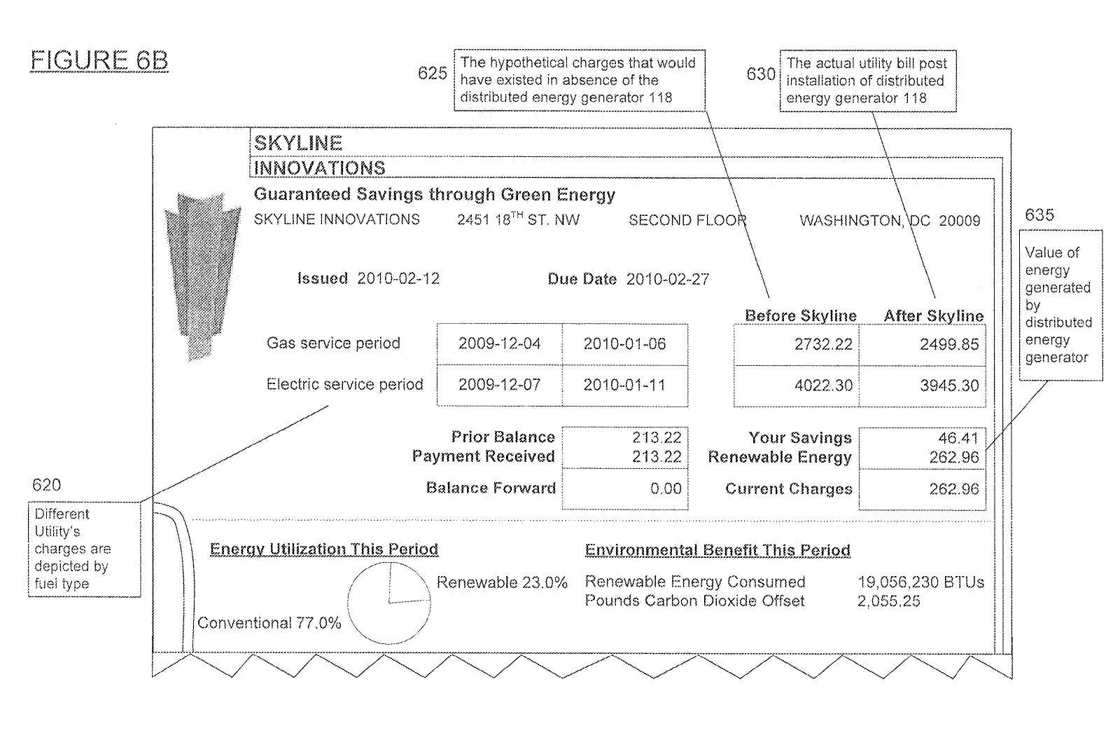

FIG. 5 illustrates a method for terminating distributed energy generator service to a customer based upon detection of tampering with the distributed energy generator 118, according to one embodiment. In 501, the customer billing system 106 can detect tampering with the distributed energy generator 118. For example, a door contact closure sensor on the data logger 101 can detect possible tampering when the contact is broken, indicating that the locked door of the data logger has been opened. In 502, the customer billing system 106 can flag the customer's account for analysis by system operators based upon the detection of tampering with the distributed energy generator 118. In 503, the system operator can review the flagged account and determine whether or not tampering with the distributed energy generator 118 has occurred. In some embodiments, some or all of this review can be automated. In 504, the system operator can switch off the distributed energy generator 118 remotely if it has been determined that tampering has occurred, as noted above.

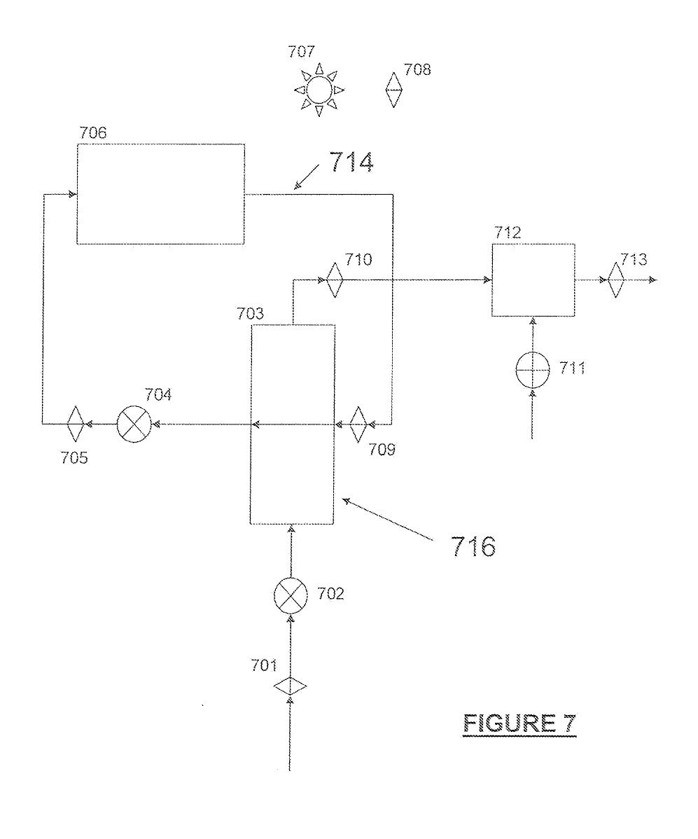

FIG. 7 illustrates an example distributed energy generator 118 in the form of a solar water heating system along with the sensors necessary for performance monitoring and thermal energy billing. In general, glycol, water, or another heat transfer fluid, circulates in a closed loop 714. Solar energy is collected by solar panel 706 and transferred to solar heated water storage tank 703. Within tank 703, energy is transferred from the closed loop 714 to water system 716. Solar heated water storage tank 703 can include an integrated heat exchanger. An electronic flow meter 704 can comprise a paddle wheel, turbine or magnetic flow sensor with an electronic output signal proportional to the rate of water flow through the sensor. Solar water heating panel input temperature electronic sensor 705 can comprise a thermistor (e.g., a thermometer that is a semiconductor device made of materials whose resistance varies as a function of temperature) or thermocouple (e.g., a thermometer comprising two wires of different metals that are joined at both ends) in a thermowell (e.g., a structure that protects a temperature sensor from harsh process conditions) or strapped to the pipe. Electronic insolation sensor 707 can produce an output signal proportional to the amount of solar irradiance received. Ambient (e.g., outdoor) electronic temperature sensor 708 can comprise a thermistor or thermocouple reading the ambient outdoor air temperature. Solar water heating panel output temperature electronic sensor 709 can comprise a thermistor or thermocouple in a thermowell or strapped to a pipe.

Sensors 704 through 709 can be used to monitor the performance of the solar water heating panel. For example, the electronic flow meter 704, input electronic temperature sensor 705 and the output temperature sensor 709 can be used to calculate the heat output of the solar water heating panel 706 by multiplying the flow rate of the fluid from the flow meter by the difference in temperature between the input electronic temperature sensor 705 and the output temperature sensor 709 and the fluid heat capacity. Thus, a flow meter 704 output of 10 pulses during one minute may correspond to a fluid flow rate of 5 kilograms per minute. An input temperature sensor 705 reading of 9.2 k Ohms may correspond to an input temperature of 50 degrees centigrade. An output temperature sensor 709 reading of 9.4 k Ohms may correspond to an output temperature of 60 degrees centigrade. The fluid can be water, with a heat capacity of 4.187 kilojoules per kilogram degree kelvin. Given these readings, the heat output of the solar water heating panel 706 is 3.49 kilowatts during this minute. (It should be noted that the sensors of FIGS. 7, 8 and 9 can include many other types of sensors.)

Referring now to water system 716, the electronic water input temperature sensor 701 can sense the temperature of the input water. The electronic potable water flow sensor 702 can determine the water flow rate. The water can then flow into the solar heated water storage tank 703. The solar heater water output electronic temperature sensor 710 can sense the temperature of the outcoming water. The water heater 712 can heat the outcoming water, if necessary. The output electronic temperature sensor 713 can sense the temperature of the outcoming water. The existing water heater energy meter 711 can determine the meter reading for the existing water heater.

Referring back to FIG. 7, electronic water input temperature sensor 701 can comprise a thermistor or thermocouple in a thermowell or strapped to the pipe. Electronic potable water flow sensor 702 can comprise a paddle wheel, turbine or magnetic water flow sensor with an electronic output signal proportional to the rate of water flow through the sensor. As noted above, solar heater water output electronic temperature sensor 710 can comprise a thermistor or thermocouple in a thermowell or strapped to a pipe. Backup or existing water heater energy meter 711 can comprise an electric energy meter with an electronic output signal proportional to the electric meter reading if the backup or existing water heater 712 is electric powered, or a gas meter with an electronic output signal proportional to the gas meter reading if the water heater 712 is gas fired. Output electronic temperature sensor 712 can comprise a thermistor or thermocouple in a thermowell or strapped to a pipe. Sensors 701, 702, and 710 can be used to bill the customer for thermal energy sold to the customer from the solar heated water tank.

For example, a flow meter 702 output of 10 pulses during one minute may correspond to a fluid flow rate of 5 kilograms per minute. An input temperature sensor 701 reading of 9.2 k Ohms may correspond to an input temperature of 50 degrees centigrade. An output temperature sensor 710 reading of 9.4 k Ohms may correspond to an output temperature of 60 degrees centigrade. The fluid can be water, with a heat capacity of 4.187 kilojoules per kilogram degree kelvin. Given these readings, the heat purchased by the customer is 0.00097 kilowatt-hours during this minute. Sensors 702, 710, 711, and 713 can be used to determine the efficiency of the backup or existing water heater 712.

For example, based upon an input temperature sensor 710 reading 9.0 k Ohms corresponding to a temperature of water of 10 degrees centigrade, an output temperature sensor 713 reading of 9.5 k Ohms corresponding to a temperature of water of 80 degrees centigrade, a flow meter reading of 100 pulses corresponding to a flow of 10 kilograms of water heated during a minute, and a natural gas meter 711 reading of 10 pulses corresponding to natural gas consumption of 1 kilowatt-hour, the efficiency of the instantaneous natural gas powered water heater is 81% since the energy requirement to heat 10 kilograms of water from 10 degrees centigrade to 80 degrees centigrade is 0.81 kilowatt-hours, and the natural gas consumption was 1 kilowatt-hour, yielding a customer gas powered equipment efficiency of 81%.

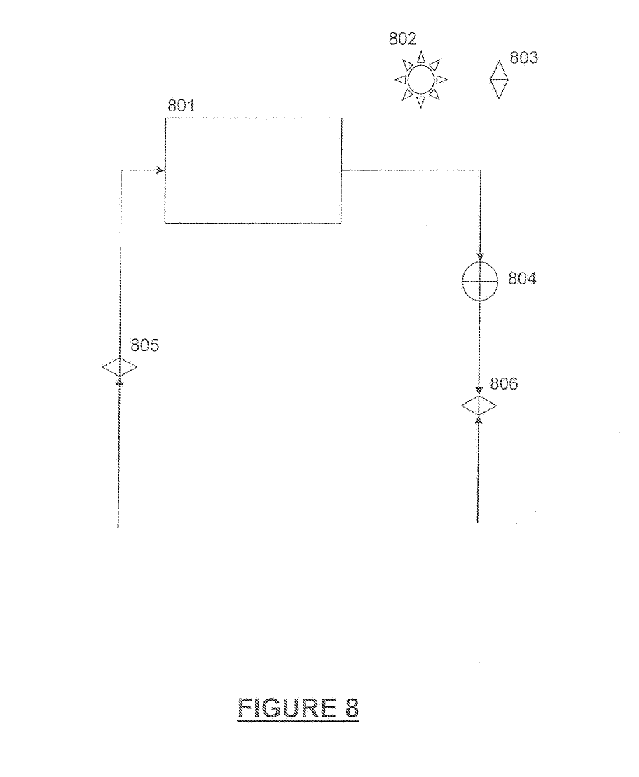

FIG. 8 illustrates an example distributed energy generator 118 in the form of a solar air heating system, along with the sensors necessary for performance monitoring and thermal energy billing. In general, the temperature of the input air can be taken by an air input electronic temperature sensor 805. Solar energy is collected by solar air heating panel 801 and transferred to air flowing through panel 801. Electronic insolation sensor 802 can determine the amount of solar irradiance-received, and ambient electronic temperature sensor 803 can take the ambient temperature. Air flow meter 804 can determine the air flow rate, and air output electronic temperature sensor 806 can take the temperature of the output air.

Referring back to FIG. 8, electronic insolation sensor 802 can produce an output signal proportional to the amount of solar irradiance received. Ambient electronic temperature sensor 803 can comprise a thermistor or thermocouple. Air flow meter 804 can comprise a vane or other air flow meter with an electronic output signal proportional to the rate of air flow through the sensor. Air input electronic temperature sensor 805 can comprise a thermistor or thermocouple. Air output electronic temperature sensor 806 can comprise a thermistor or thermocouple. Sensors 804, 805, and 806 can be used to bill the customer for thermal energy sold to the customer from the solar air heater.

For example, the electronic air flow meter 804 input electronic temperature sensor 805 and the output temperature sensor 806 can be used to calculate the heat output of the solar air heating panel 801 by multiplying the flow rate of the air from the flow meter 804 by the difference in temperature between the input electronic temperature sensor 805 and the output temperature sensor 806 and the air heat capacity. For example, an air flow meter 804 output of 10 pulses during one minute may correspond to an air flow rate of 5 kilograms per minute. An input temperature sensor 805 reading of 9.2 k Ohms may correspond to an input temperature of 50 degrees centigrade. An output temperature sensor 806 reading of 9.4 k Ohms may correspond to an output temperature of 60 degrees centigrade. The heat capacity of air is 1.012 kilojoules per kilogram degree kelvin. Given these readings, the heat output of the solar water heating panel 806 is 0.84 kilowatts during this minute.

Sensors 802 through 806 can be used to monitor the performance of the solar air heater. For example, sensors 804, 805, and 806 can be used to calculate the heat output of the solar air heater 801 as stated in the previous example. Insolation sensor 802 and ambient outdoor temperature sensor 803 can be used by the analytical tools 116 to compare the heat output of the solar air heater 801 to similar data points as described in the description of FIG. 1.

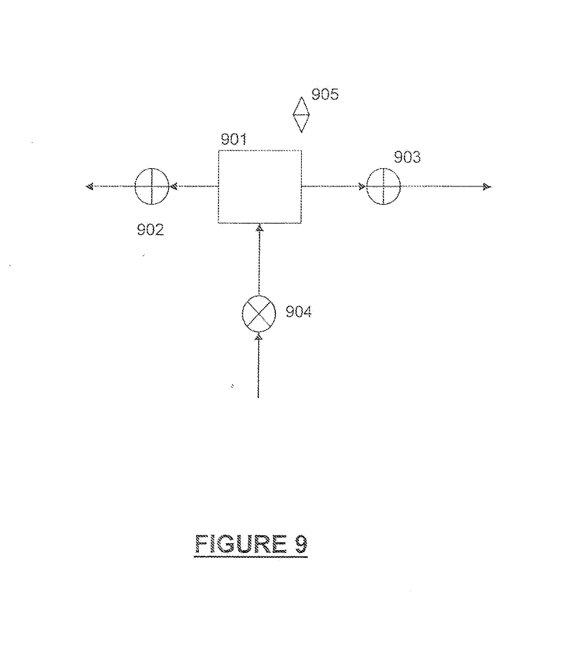

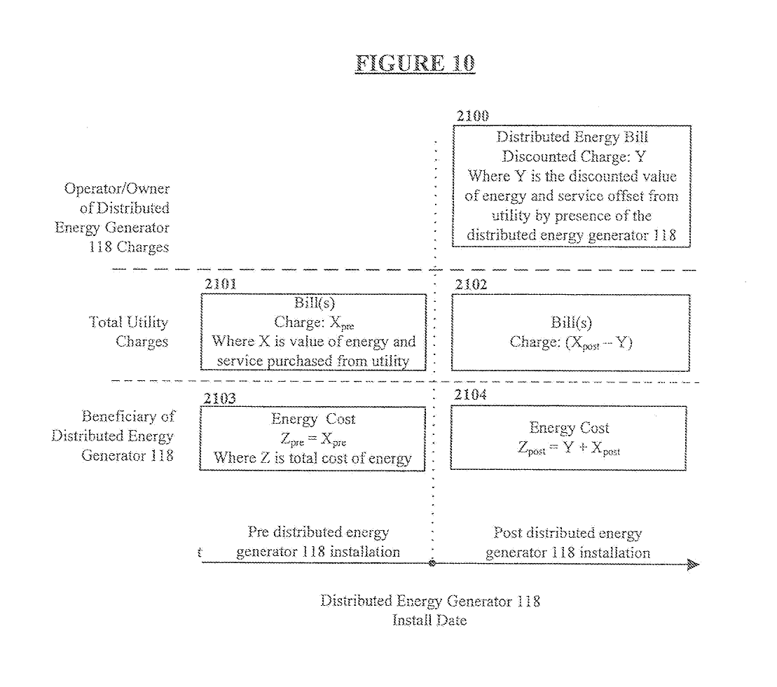

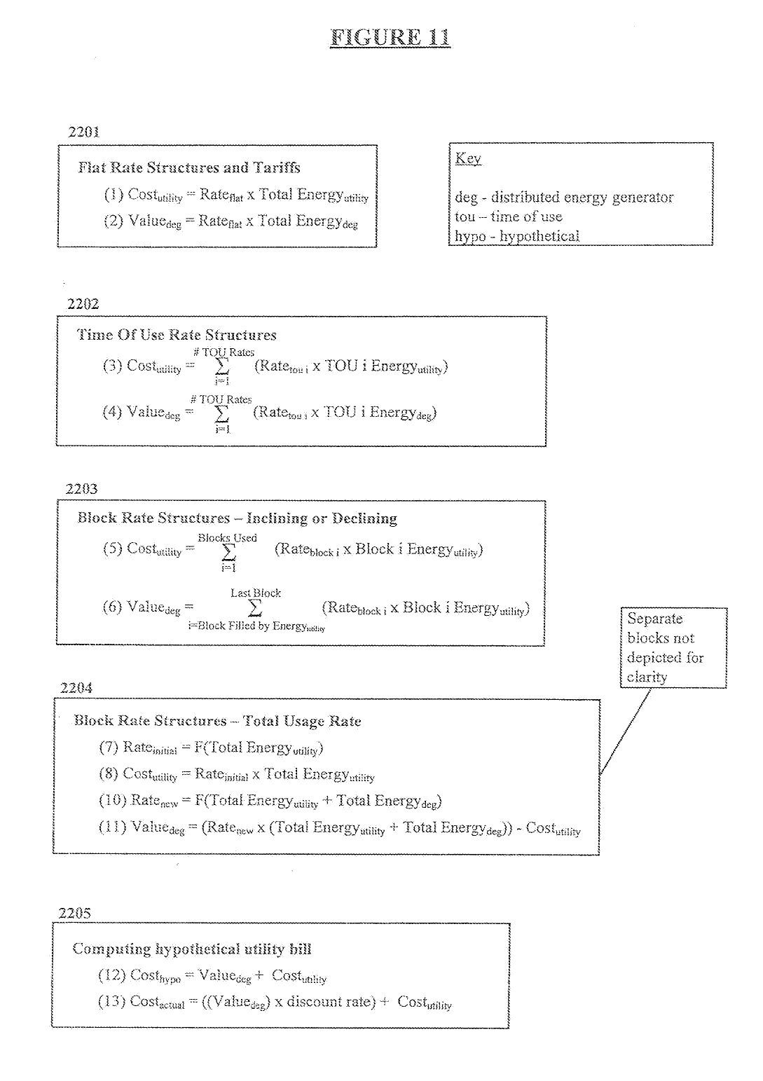

FIG. 9 illustrates an example distributed energy generator 118 in the form of a fuel cell system, along with the sensors necessary for performance monitoring and electrical and thermal energy billing. In general, the meter reading can be taken from a natural gas meter 904 as natural gas flows into a natural gas fuel cell electrical generator 901. The ambient temperature can be taken by ambient electronic temperature sensor 905. The electrical energy meter 903 can determine the meter reading for the electrical energy output of the fuel cell 901, and the thermal energy meter 902 can determine the meter reading for the thermal energy output (e.g., a waste product) of the fuel cell 901.

Ambient electronic temperature sensor 905 can comprise a thermistor or thermocouple. Electric energy meter 903 can comprise an electronic output signal proportional to the electric meter reading. Natural gas meter 904 can comprise an electronic output signal proportional to the gas meter reading. Thermal energy meter 902 can comprise an electronic output signal proportional to the thermal energy meter reading. Thermal energy meter 902 and electrical energy meter 903 can be used to bill the customer for the thermal and electrical energy produced by the fuel cell.

For example, during a 10 minute interval, thermal energy meter 902 may produce 5 pulses, and electrical energy meter 903 may produce 10 pulses. This data can be gathered by data logger 101 and sent to the customer billing system 106 which determines that the thermal energy meter 902 pulse output of 5 pulses corresponds to thermal energy sold to the customer of 1 kilowatt-hour and the electrical energy meter 903 pulse output of 10 pulses corresponds to electrical energy sold to the customer of 3 kilowatt-hours. This data can be sent to the customer billing engine 115, which can compare the energy purchased by the customer from the fuel cell distributed energy generator 901 and the customer's traditional utility rate structure data 113 to generate a bill for the customer which charges the customer for the output of the fuel cell distributed energy generator 901 according to the customer's traditional utility's existing rate structure.

In some embodiments, the fuel cell uses natural gas to produce electricity and heat, and therefore can increase the customer's natural gas bill. Thus, the billing system can credit the customer for the natural gas consumed in this case, since, in some embodiments, the customer is charged for the electricity (and perhaps heat) generated by fuel cell 901. Natural gas meter 904 can be used to credit the customer for natural gas consumed by the fuel cell. For example, during a 10 minute interval, gas meter 904 may produce 15 pulses. This data can be gathered by data logger 101 and sent to the customer billing system 106 which determines that the gas meter 904 pulse output of 15 pulses corresponds to natural gas used by the fuel cell distributed energy generator 901 of 5 kilowatt-hours. This data can be sent to the customer billing engine 115 which can compare the natural gas used by the fuel cell distributed energy generator 901 and the customer's traditional gas utility rate structure data 113 to generate a credit for the customer which credits the customer for the natural gas consumption of the fuel cell distributed energy generator 901 according to the customer's traditional utility's existing rate structure.

FIGS. 14-17 and 19-21 relate to aspects of the billing engine 115. In one embodiment, the value of distributed energy generation to a customer in terms of the impact to one or more utility bills received by the customer can be determined. Without distributed energy generation, the cost of all energy used can be paid to the utility by the customer. With distributed energy generation, the cost of all energy used can be split between the utility(ies) and the owner/operator(s) of the distributed energy generator 118. The amount that the customer would have paid to the utility in absence of a distributed energy generator 118 after a distributed energy generator 118 has been installed can be calculated. This value, when the actual utility bill is subtracted, represents the value from the distributed energy generator 118.

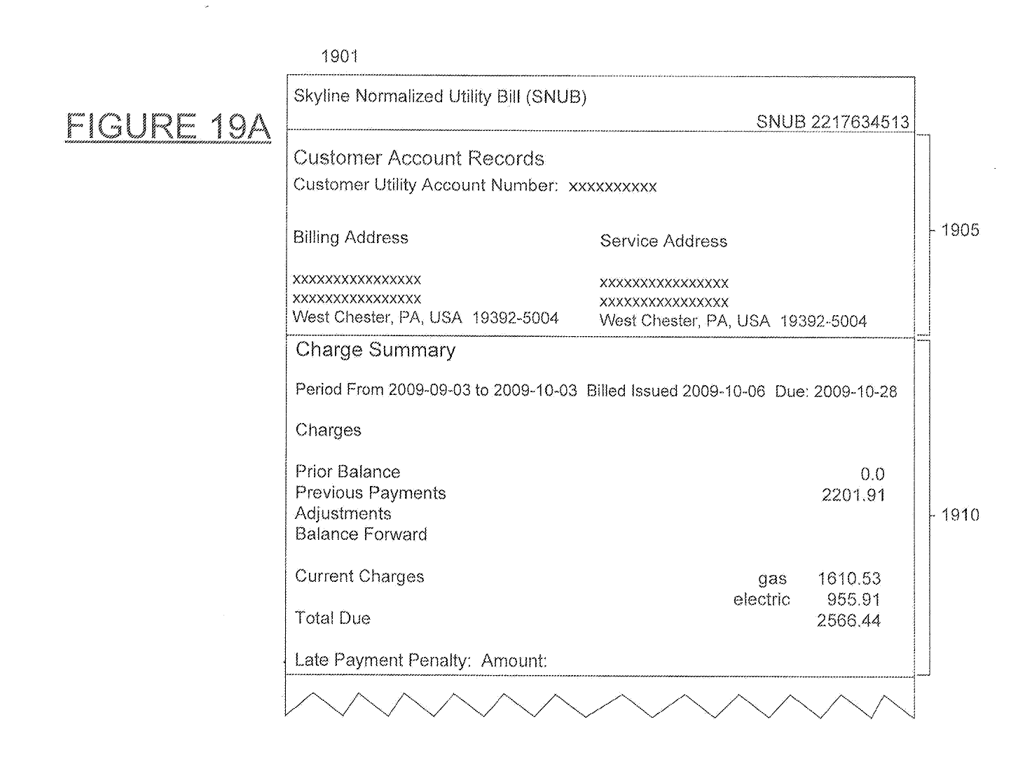

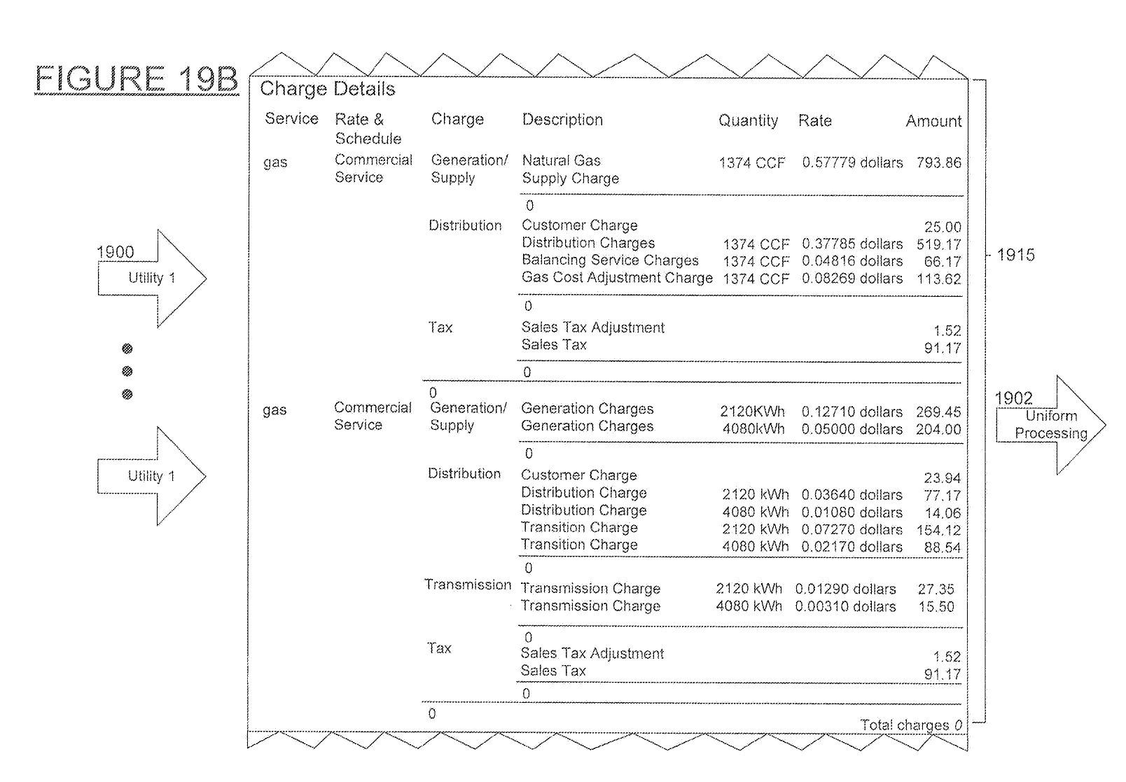

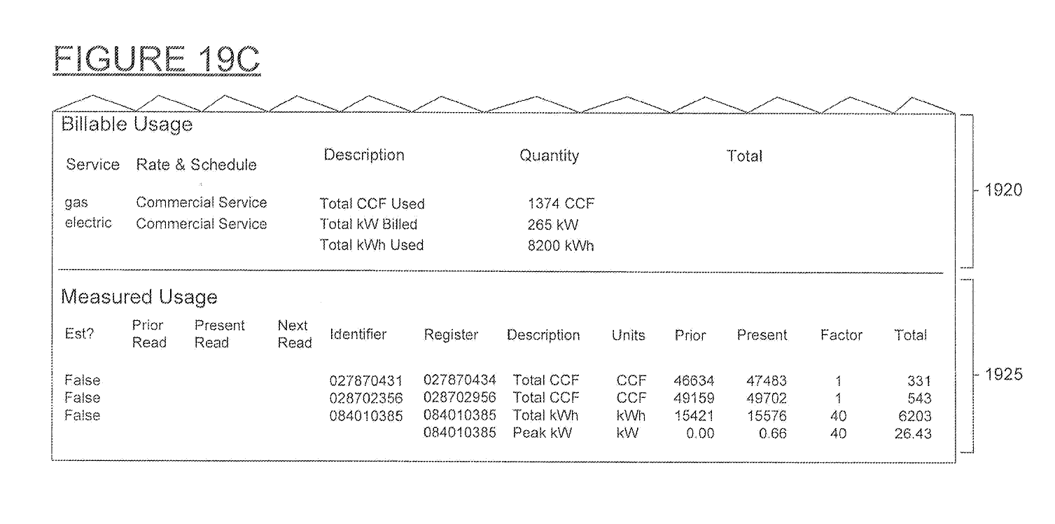

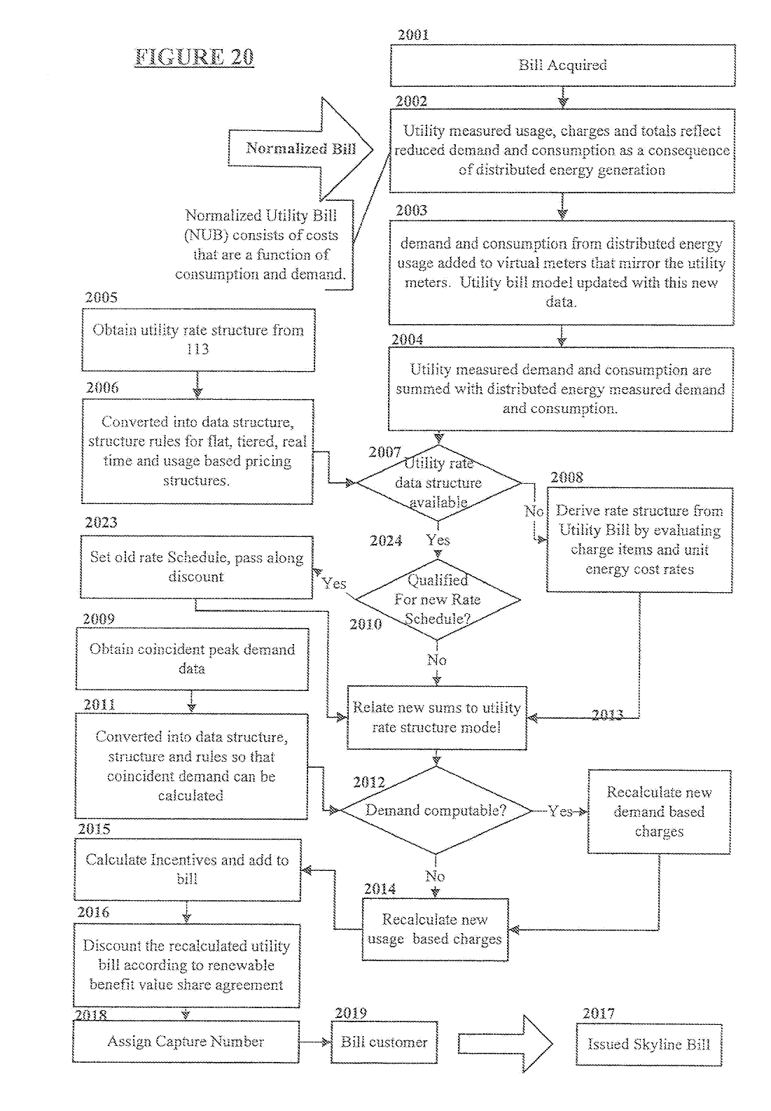

FIG. 14 illustrates information that can be used to model any given utility bill 109 and information that can be used to model any given rate structure 113, according to several embodiments. Given these models, the necessary data may then be stored to compute the value of the distributed energy generator 118 as if its energy was originally included in one or more utility bills. The utility bill model 1400 can include: utility information 1401, utility customer information 1402, bill charge summary information 1403, bill charge details 1404, billable usage information 1405, measured usage information 1406, usage history information 1407, or any combination thereof. The utility information 1401 can include business location and contact information for the utility. The utility customer information 1402 can include location and contact information for the customer. The bill charge summary information 1403 can include a summary of the bill charges. For example, section 1910 of FIG. 19 illustrates example bill charge summary information 1403. The bill charge detail information 1404 can include detailed information of the bill charges. For example, the type of service, the type of rate, the charge category and description, quantity, rate and amount can be listed. Section 1915 of FIG. 19 illustrates example bill charge details 1404. The billable usage information 1405 can include the type of service and rate schedule, the description, quantity and total amount of energy used. For example, section 1920 of FIG. 19 illustrates example billable usage information 1405. The measured usage information 1406 can include prior read information, present read information, next read information, register and identifier information, and unit information. For example, section 1925 of FIG. 19 illustrates example measured usage information. The usage history information 1407 can include information on the historical energy usage for a particular customer.

The utility rate structure model 1410 can be a data structure that can contain a complete set of information describing the utility's rates and tariffs that comprise all costs shown on a utility bill. This complete set of information can allow for the calculation of a hypothetical utility bill based on energy supplied by the utility and energy supplied by the distributed energy generator.

A utility rate structure can comprise descriptive information about the utility such as: the utility information 1415 (e.g., business location and contact information for the utility), the published tariff 1520 (e.g., network location of published tariff and rate documentation and the quantitative rate structure that describes the costs per unit energy from the utility), and the rate structure 1425. Utility rate structures can be simple rate structures 1411, which can include flat rates 1413, time of use rates 1414, inclining block rates 1415, or declining block rates 1416, or any combination thereof. A flat rate 1413 can be an invariant rate which is multiplied by the amount of energy used. For example, 0.14 dollars per kWh or 4.00 dollars per kWD. A time of use rate 1414 can be a flat rate that is bounded by intervals of time. For example, 0.10 dollars per kWh from 12 AM to 6 AM, 0.18 dollars per kWh from 6 AM to 6 PM and 0.16 dollars from 6 PM to 12 AM. A block rate structure rate can be based on amounts of energy supplied. An inclining block rate 1415 can increase for each additional block of energy supplied while a declining block rate 1416 can decrease for each additional block of energy supplied. For example, an inclining block rate for natural gas fuel may be 0.40 dollars per therm for the first 300 therms and 0.50 dollars per therm thereafter. A declining block rate behaves in an opposite manner.

Utility rates may also be complex rates 1412, and can include usage based block rates 1417 and hybrid rates 1418. A usage based block rate 1417 can be determined as a function of total usage. For example, if 300 kWh are supplied, the rate is 0.10 dollars per kWh but if more than 300 kWh are supplied, the rate is 0.19 kWh. This type of rate can be used for demand charges as well. Complex rates 1412 can also include hybrid rates 1418, which can be a combination of many types of rates that can occur in regulated and deregulated markets. These rates can be modeled in the utility rate data structure. Examples of such rates are real time pricing, variable rates based on a monthly wholesale price and a myriad of others known by those of ordinary skill in the art.

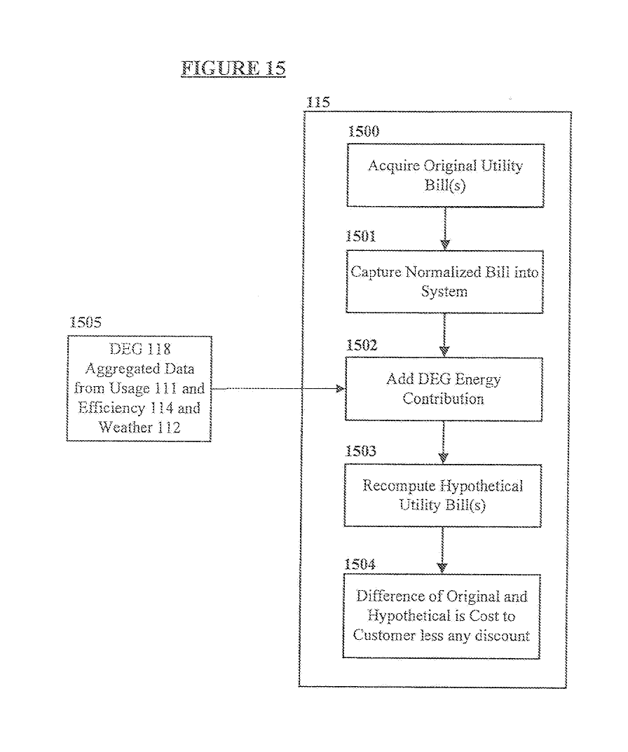

FIG. 15 illustrates an overview of how the billing engine 115 compares customer usage of energy and customer equipment efficiency to determine new billing charges (210), according to one embodiment. In 1501, original utility bills can be acquired and normalized. In 1502, distributed energy distributor 118 energy contributions (e.g., solar panels, solar water heaters) made during the utility billing period can be added to the utility's metering configuration. (It should be noted that any changes to the customer record such as billing address, and relevant changes to the charge summary, charge detail, measured and billed usage can also be made.) In 1503, a hypothetical bill can be recomputed. In 1504, the difference between the original bill and hypothetical bill can be computed. This is the cost that can be charged to the customer, less any discount or plus any additions. It should be noted that, in 1505, energy data produced from the distributed energy generator logger 101 and other results of calculations such as premises equipment efficiency can be contributed in a manner such that the adjusted energy production can be taken into account when adding in the distributed energy generator 118 energy contribution in 1502.

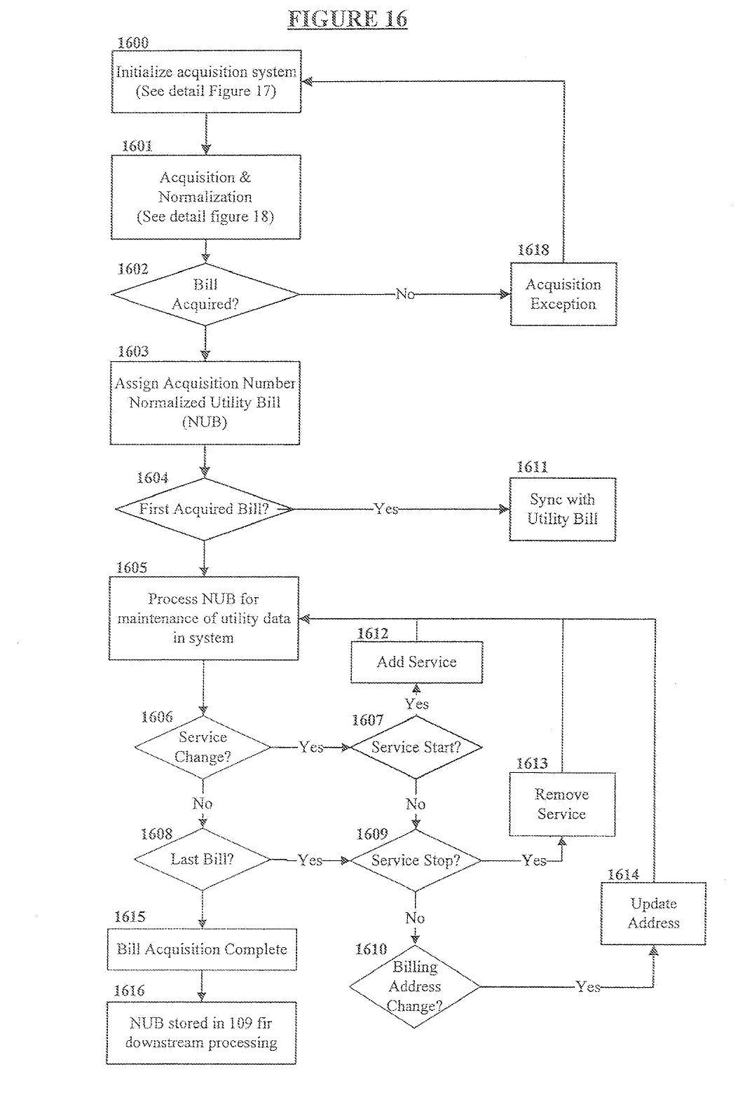

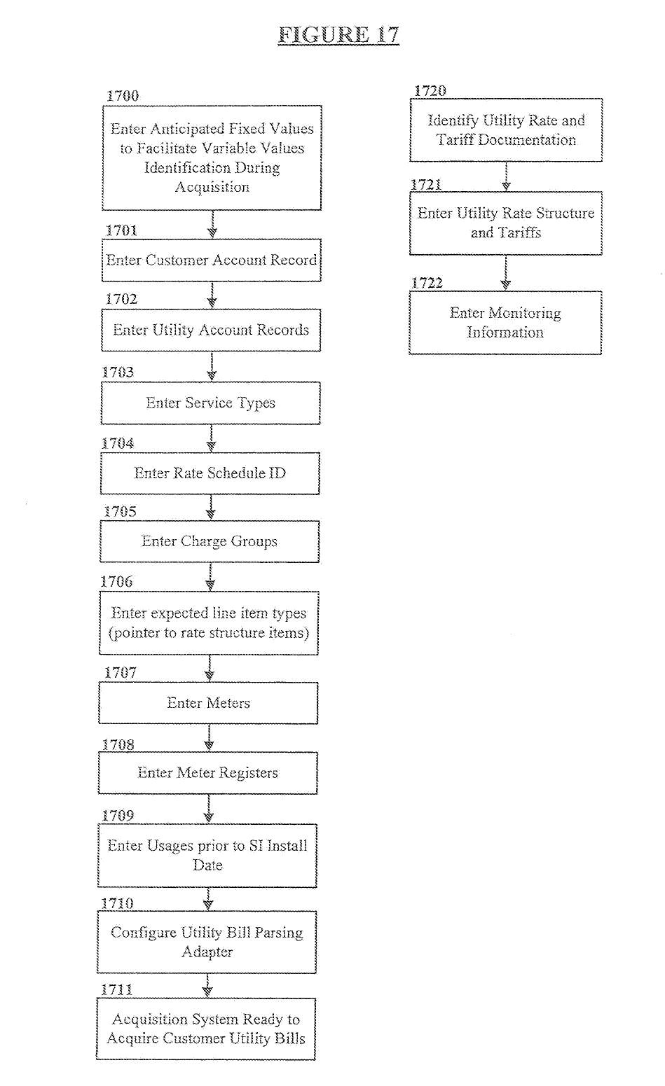

FIG. 16 illustrates details related to acquiring and normalizing the original utility bill (1501), according to one embodiment. In 1600, the acquisition system can be initialized (described in detail in FIG. 17). In 1601 the acquisition and normalization takes place (described in detail in FIG. 18). Should a problem occur during acquisition the system can be reinitialized and rerun. When the bill is successfully acquired in 1602, the necessary normalized bill fields can be completely populated. In 1603, a normalized bill ID can be assigned when all acquisition criteria is satisfied. This can allow for subsequent normalized processing that allows business rules independent of utilities to be executed. In 1604, if the acquired, normalized bill is the first utility bill to take into account the distributed energy generator 118, in 1611, it can be shown that a customer has been provisioned and that usage, account balances and dates must be related to distributed energy production from those points forward such that the utility bill usage and rate data can be synchronized with the distributed energy production data. For example, if a customer starts using the distributed energy generator 118 on January 10th, the bill for January will only take the information related to the distributed energy generator 118 into account after January 10th. It should be noted that, because previous bill information can be received, it can be estimated when the distributed energy generator 118 first began to be used. In 1605, normal routine processing can occur to create a normalized utility bill (NUB). In 1606, service changes can be handled. If a service change has occurred, in 1607, it can be determined if the service has started. If so, in 1612, the new utility service can be added. The routine processing can then reoccur in 1605. If there is not service change, in 1608, it can be determined if it is the last bill. If so, it can be determined whether the service should stop in 1609. If yes, in 1613 the service can be removed and the bill can be reprocessed in 1605. If no, the service shouldn't stop, in 1610, it can be determined if the billing address should change. If yes, in 1614, the address info (and/or other basic info on the bill) can be updated and the bill can be reprocessed in 1605. If it is the last bill, in 1615, the acquisition is complete 1615 and the normalized utility bill can be frozen so that accounting and auditing may be performed.

FIG. 17 illustrates details related to the initialization of the utility bill acquisition system (1600 of FIG. 16), according to one embodiment. Initialization can be done so that automated acquisition can be performed with high confidence. Utility bills share common characteristics (e.g., utility information, utility customer information (name, date, etc.). These characteristics can be input in 1700 prior to multi-modal acquisition (e.g., the acquiring of information in different ways (e.g., paper bill, utility web site) from different utilities) so that prior facts are known thereby increasing the confidence of acquisition. In 1701, some or all of the customer account record can be entered. In 1702, utility account records such as tax identifier and remittance addresses can be entered. In 1703, the service types (e.g., gas, electric, propane) can be acquired. In 1704, the rate schedule name (e.g., names of plans determined by the utility, such as basic service rate, industrial gas supply) can be entered. Because of pre-qualification, the utility service type information, the rate schedule name information, and the cost of energy (e.g., per kilowatt hour) can be determined for various types of services (e.g., gas, electric). During this pre-qualification process, there can be much customer contact and historical utility bills can be obtained (e.g., thus giving the utility service type and the rate structure). For example, during pre-qualification, the amount of hot water consumed per unit time and the cost for a certain customer can be accessed.

In 1705, the utility bills can reflect charges that, while not grouped in the utility bill, can be grouped in an independent representation of the bill (e.g., grouped as energy generation, energy distribution, etc.). In 1706, expected line item types can be entered so that automated analysis of the utility charges can be performed. For example, if a particular utility's first three lines of a bill are for different kinds of energy generation, these can be grouped together. If the utility's last two lines of a bill are for distribution charges, these can be grouped together. In 1707, meters can be entered. For example, the identification number and nature of any meters can be entered. A finite number of meters can exist at a customer premises. In 1709, usage information (up to the distributed energy plant install date) can be reviewed to provide additional facts for subsequent bill acquisition (e.g., do meter registers properly line up; i.e., are they correct?). For example, if total usage for January 1-10 (before the distributed energy generator 118 was installed) was 50 kilowatt hours, then the total usage for January 1-31 should be more than 50 kilowatt hours. Given these facts, in 1710, the utility bill can be configured using a parsing adapter. The parsing adapter can review data from all utilities, even though the information from each utility may come in a different way (e.g., paper, email, website).

In 1721, the utility rate and tariffs (e.g., taxes) can be input into the acquisition system through identification of the appropriate rate and tariff documentation. In addition to this data, in 1722, information about the valid dates (e.g., billing period) and network location of where a particular utility bill is accessible can be stored for automated monitoring of changes to the rate and tariffs.

FIG. 19 illustrates a normalized utility bill, according to one embodiment. Multiple utilities provide bills 1900 through multiple modalities. These bills are normalized into a common data model whose presentation is shown in 1901. Subsequent uniform processing is then applied to each normalized bill in 1902. The remainder of FIG. 19 is explained with respect to the explanation of FIG. 14.

FIGS. 6A and 6B illustrate example images of actual bills. In 605, computed hypothetical utility detail charges are computed as if the distributed energy generator 118 was not present. In 615, utility bill totals are shown which are subtracted, from the actual utility bill charges to compute the benefit from the distributed energy generator. In 610, the energy produced by the distributed energy generator is decomposed into virtual registers that match the registers used by the utility to bill the customer. In 620, different utility's charges are depicted by fuel type. In 625, hypothetical charges that would have existed in the absence of the distributed energy generator 118 are shown. In 630; the actual utility bill after installation of the distributed energy generator 118 is shown. In 635, the value of the energy generated by the distributed energy generator 118 is shown.

FIG. 20 illustrates the normalized utility bill capture process, according to one embodiment. In 2001, a capture process can receive a normalized utility bill and add distributed energy production data to it in order to compute a hypothetical bill that would be paid to the utility in the absence of a distributed energy generator. The difference between the two represents the net value to the customer. In 2002, normalized summary, charges, usage and totals from a utility can reflect reduced usage and demand as a consequence of the presence of the distributed energy generator 118. Since usage and demand determine utility charges, the combined usage and demand may need to be considered to compute the hypothetical utility bill which would have existed as a consequence of the absence of the distributed energy generator. In 2003, the summation of the utility bill usage and demand and distributed energy generator can be accomplished by creating virtual meter registers that mirror the real meter registers.

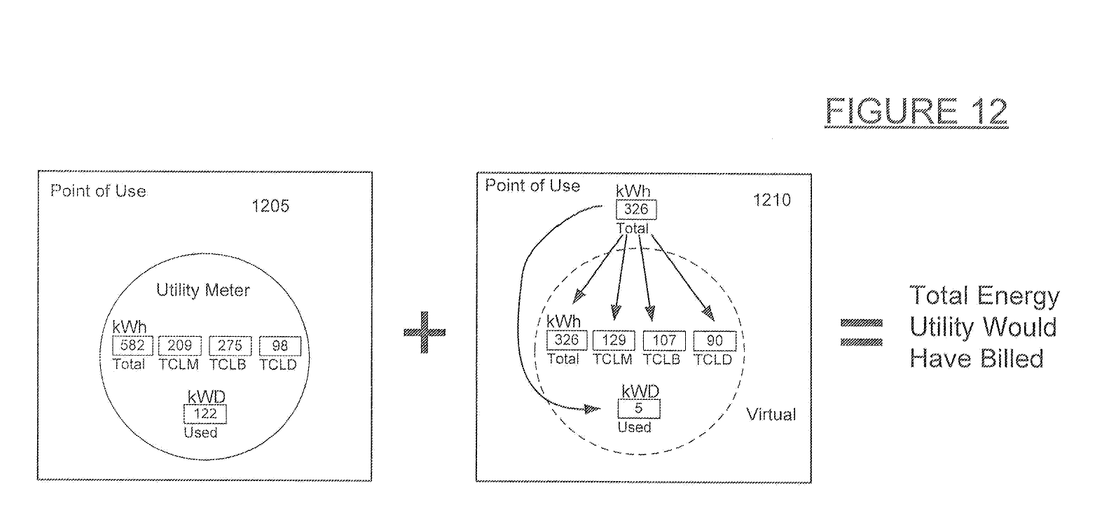

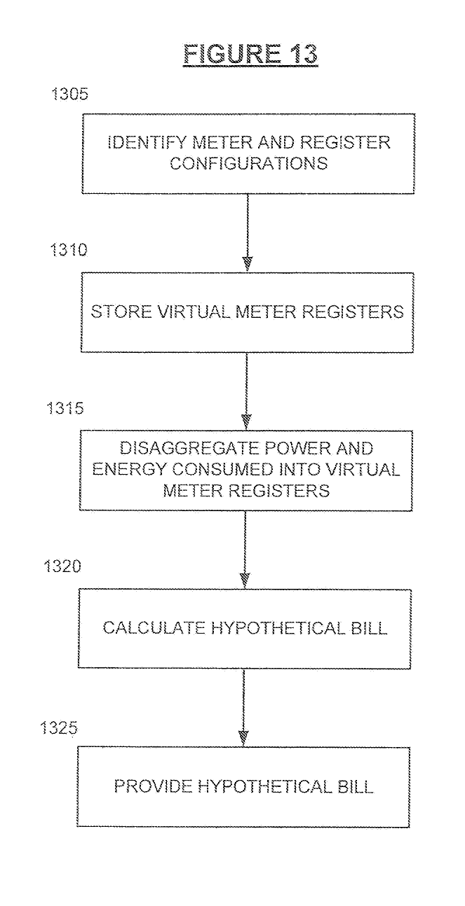

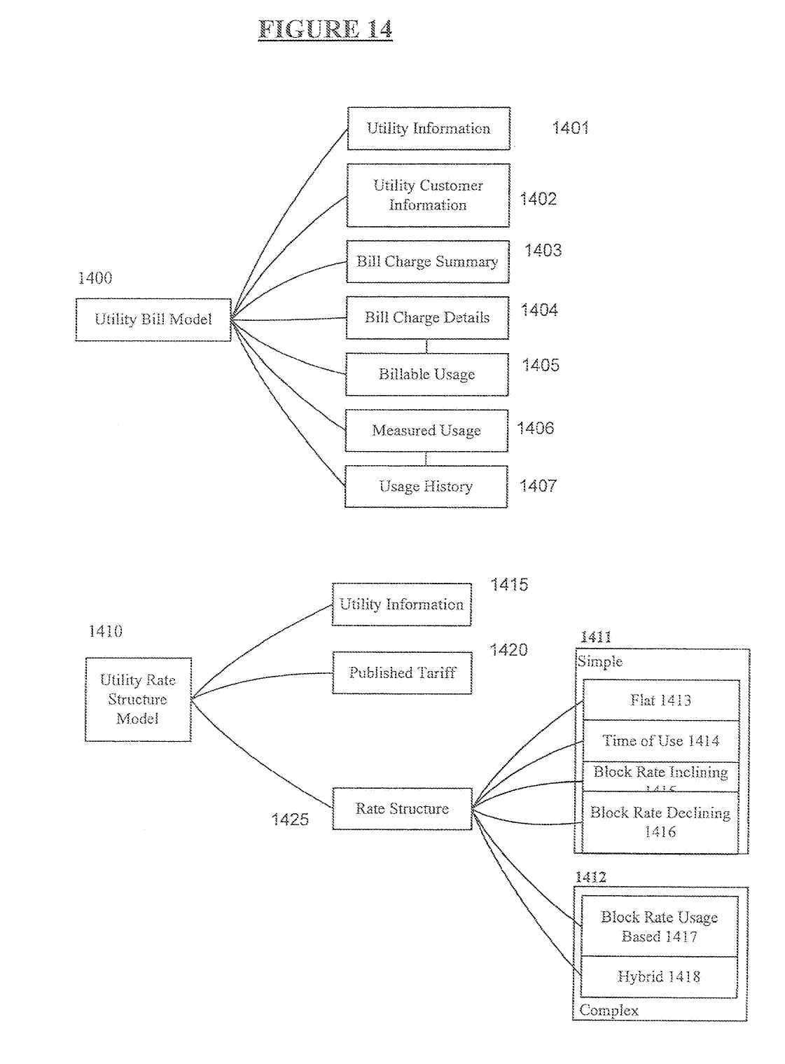

FIGS. 12-13 provide details regarding virtual meter registers. FIG. 12 illustrates the relationship between one or more physical meters at a location, and the virtual registers that can disaggregate the energy measured by the'distributed energy generator 118. In point of use 1205, a utility meter and example registers are illustrated. These register values, which can be the amounts of energy consumed from the utility, can be reflected on a monthly utility bill. In data processor 1210, the total amount of energy generated by the distributed energy generator 118 is shown. In addition, the amount of energy recorded into virtual registers that can mirror and can be structured as a function of the utility meter registers is illustrated. The virtual registers can obey the rules set forth in the utility rate structure 1400 of FIG. 14. Thus, when the virtual registers are populated with the total amount of energy from the distributed energy generator 118, they can be mathematically summed with the actual registers of the utility meter. This summation can be used as a basis for the calculation of a hypothetical utility bill.

It should be noted that a virtual meter register can be a memory location in a data processor that is used to disaggregate renewable energy generated by a distributed energy generator 118. Virtual meter registers can be necessary to compute the value of energy in terms of a utility bill.

Utilities can measure energy consumption at the point of use by one or more meters that have one or more registers that measure power or energy according to a set of arbitrary business rules. For example, a utility may place a demand meter that measures the maximum 30 minute load averages and stores that value in a register addition to a net energy meter that records total energy use as well as, for example, three times of use and then stores those values in four registers.

The set of registers the utility places at a given point of use location can be the registers that are used to generate a bill that the utility presents its customers. Associated with each register can be proprietary business rules defined in the utility rate structure. Given the values placed in the register, these rules can then be used to compute the cost of energy. For example, a demand register may record 30 kWD and time of use registers may record 100 kWh, 150 kWh and 75 kWh for three time periods that comprise a day (e.g., on-peak consumption (8 AM to 10 PM); shoulder consumption (6-8 AM and 10 PM-12 Midnight); and off-peak consumption (Midnight-6 AM). These amounts of power and energy can then be multiplied by rates found in the rate structure.

In order to compute the value of power and energy generated from a distributed energy generator in the same location in a way that illustrates the value of its energy in terms of what the utility would have charged, it may be necessary to disaggregate the total amount of energy and power recorded for the distributed energy generator according to the utility meters and virtual meter register business rules. To do this, the utility meters and registers can be initially known and a matching set of virtual meter registers can be created into which the power and energy of the distributed energy generator can be dynamically or periodically recorded. The amounts of power and energy found in the utility registers and the amounts of power and energy found in virtual meter registers may be totalized. These totals can then represent what the customer would have been billed by the utility. Therefore, the value of the distributed energy generator's energy and power can be easily computed by taking the existing utility bill and then re-computing the bill with the added virtual meter register values.

Referring to FIG. 13, a flow chart is provided indicating how to identify virtual meter registers. In 1305, meter and register configurations can be identified for given location. In 1310, virtual meter registers can be stored for each identified register configuration. In 1315, for a given billing period, distributed energy generator total power and energy consumed can be disaggregated into virtual meter registers according to utility rate structure. In 1320, a hypothetical utility bill can be calculated based on the amount of power and energy consumed by adding utility registers to virtual meter registers. In 1325, a hypothetical utility bill can be provided, which can discount renewable energy.

Referring back to FIG. 20, in 2004, time series data from the distributed energy generator can be accumulated into the virtual meter registers. At this point the total demand and usage can be known. In 2007, the bill can be further associated with rate structure information, which can be obtained from utility records and converted into a normalized form in 2006. Should the rate structure not be available, in 2008, the rate structure can be derived from the normalized utility bill (e.g., in cases where the rate schedule is not complex). In 2009, for certain demand computations, the coincident peak demand data can be obtained. In 2013, the demand charges can be computed, if possible, and the usage charges can be computed in 2014. For usage based demand charges, as in the case of a block structure based on usage, total usage need only be known. In cases where the distributed energy generator contributes enough energy, the customer may qualify for a more favorable rate schedule from the utility. In this instance, in 2024, the system can evaluate utility rate structures and if it is determined that the customer qualifies, the customer can be notified. If the customer qualifies and the new rate schedule is present in the utility bill, in 2023, the billing system can then recompute the utility bill according to the rate schedule that would have applied if no distributed energy generator was present (e.g., depending on discount rate and particular business arrangement). In 2015, additional variable rates, such as sales tax and environmental charges, can be computed. In 2016, the resultant hypothetical utility bill can be discounted in a contract specific manner and issued to the customer in 2017.

FIG. 10 illustrates how the distributed energy generator production relates to the utility bill, according to one embodiment. Prior to the installation date, in 2101, one or more utilities can charge the beneficiary Xₚᵣₑ. Therefore, in 2103, the as of-yet beneficiary of the system can pay an amount of money Zₚᵣₑ to one or more utilities that provide energy services. In 2013, since no distributed energy system exists, Zₚᵣₑ equals Xₚᵣₑ. After the installation date, in 2100, the distributed energy generator 118 can produce energy Y that can be utilized by the beneficiary of the system, thus, in 2102, reducing the amount of energy purchased Xₚₒₛₜ−Y from the utility. In 2104, the utility energy rates can be applied with discount to Y and the beneficiary can then be responsible for paying a new amount of money Zₚₒₛₜ that reflects the newly reduced utility charges and the discounted energy cost paid to the operator/owner of the distributed energy generator 118.

For example, a customer of a utility may pay $500 to an electric utility and $250 to a gas utility. In the presence of the distributed energy generator 118, these bills may be reduced to $300 and $100 respectively. This reflects a lower amount of energy and service consumed from the utilities. The distributed energy generator 118 has contributed energy which has offset these utility bills. This contributed energy is added to the energy found in the utility bill and the utility bill is recomputed. This newly computed bill reflects what would have been consumed from the utilities in absence of a distributed energy generator 118. This new hypothetical bill has the actual bill subtracted from it resulting in the amount of money saved by the distributed energy generator 118.

It should be noted that one theory behind calculating the benefit of the distributed energy generator is:

Host Bill (e.g., Skyline)=Hypothetical Utility Bill(s)−Actual Utility Bill(s)

A hypothetical utility bill can be calculated by a multi-step process. For a given billing period, the energy consumed from the distributed energy generator has been measured over time. For example, between the utility bill dates of Dec. 3, 2009 and Jan. 2, 2010, a distributed energy generator may have generated 2,100,232 BTUs but 1,902,294 were consumed from it over that time. The value of the energy consumed over time can be computed. To compute the value of this energy, the energy can be measured in a way that allows a hypothetical utility bill to be computed. To do this, the energy consumed over time can be distributed across the meter registers found in the actual utility bill in accordance to the rules found in the utility rate structure.

For example, a customer utility bill and rate structure can show that a customer is on a time of use rate and has four meter registers: 475 T for total consumption, D11 for off peak consumption, D08 for shoulder consumption and D05 for on peak consumption. These registers are kilowatt hour registers. D11 is valid from 12 AM to 6 AM, D08 is valid from 10 PM to 12 AM and 6 AM to 8 AM and D05 from 8 AM to 10 PM. The 1,902,294 BTUs measured during the bill period can then be distributed across the D11, D08 and D05 meter registers. D11 may have 19 kWh, D08 9 kWh and D05 30 kWh.

The amount of energy consumed over time can now be defined according to the actual utility bill registers. This amount of energy can then be added to the actual utility bill registers so that a hypothetical bill may be created. Once the amount of energy consumed from both the utility and the distributed energy generator is determined, a hypothetical utility bill may be computed.

For example, the utility bill for Dec. 3, 2009 to Jan. 2, 2010 shows that the meter registers D11 had 16 kWh, D08 6 kWh and D05 7 kWh. Since the 1,902,294 BTUs translated into D11 19 kWh, D08 9 kWh and D05 30 kWh, the totals are then D11 16+19 kWh, D08 6+9 kWh, and D05 7+30 kWh.

Given the new utility meter register values, the detail charges on the actual utility bill can be recomputed. The utility rate structure can provide the cost of energy along with the myriad of tariffs associated with purchasing energy.

For example, a set of actual utility bill charges can look like:

| | | | |
|---|---|---|---|
| Usage | 300.0 Therms | 0.3007 dollars | 90.21 dollars |
| Usage | 24.8 Therms | 0.2 dollars | 4.96 dollars |
| System Charge | 36.25 | | |
| MD Sales Tax- | 131.42 dollars | 6.0 percent | 7.89 dollars |
| Distribution | | | |
| MD Receipts | 0.05 dollars | | |
| Surcharge | | | |
| PG County | 324.8 Therms | 0.0829060 dollars | 26.93 dollars |
| Energy Tax | | | |

But when the distributed energy generator energy is added (here it generated 5.65 Therms), the hypothetical charges can look like:

| | | | |
|---|---|---|---|
| Usage | 300.0 Therms | 0.3007 dollars | 90.21 dollars |
| Usage | 30.45 Therms | 0.2 dollars | 6.09 dollars |
| System Charge | 36.25 | | |
| MD Sales Tax- | 132.55 dollars | 6.0 percent | 7.95 dollars |
| Distribution | | | |
| MD Receipts | 0.05 dollars | | |
| Surcharge | | | |
| PG County | 330.45 Therms | 0.0829060 dollars | 27.40 dollars |
| Energy Tax | | | |

Once the detail charges have been recomputed on top of the actual utility bill, the hypothetical utility bill has been determined. The actual utility bill can then be subtracted from the costlier hypothetical utility bill to determine the value of the energy consumed from the distributed energy generator.

FIG. 11 illustrates several example types of rate structures, all of which can also have flat rates for various tariffs. 2201 shows a formula for a flat rate structure, according to one embodiment. 2201 includes the formula for also calculating the taxes and other charges that are a function of energy consumption. Examples of (1) and (2) are:

0.00012 dollars per kWh*2400 kWh=0.29 dollars (1)

0.00012 dollars per kWh*900 kWh=0.11 dollars (2)

6% sales tax×(2400 kWh*0.00012 dollars per kWh)=0.02 dollars (1)

6% sales tax×(900 kWh*0.00012 dollars per kWh)=0.001 dollars (2)

2201 shows a time of use rate structure, according to one embodiment. This rate structure can be calculated by adding all of the time of use totals together.

((0.0004 dollars per kWh from 12 AM to 6 AM)*12387 kWh)+((0.0123 dollars per kWh from 6 AM to 8 AM and 10 PM to 12 AM)*5432 kWh) ((0.026 dollars per kWh from 8 AM to 10 PM)*40327 kWh)=4.95 66.81+1048.50=1120.26 (3)

2203 shows block rate structures, according to several embodiments, where subsequent blocks of consumption become increasingly more or less expensive depending on the rate structure.

(First 300 Therms*0.3 dollars per Therm) (425 Remainder Therms*0.2 dollars per therm)=$175 (5)

2204 shows block rate structures, according to several embodiments, where where the energy contract is a function of consumption and negotiations. For example, should a utility customer consume 45 MWh, the utility may assign a flat rate or a block rate that is a function of such large consumption. Should the consumption of 45 MWh merit a flat rate of 0.09 dollars per kWh (7) then (8) is 45,000 kWh*0.09 dollars per kWh=$4,050.

2105 illustrates the types of rate calculations in 2201-2204, as they can be tied together, according to one embodiment. Some utility bills also have flat rates for taxes and environmental charges, computed by a formula similar to 2201 (1). These can be considered as part of the value provided by the distributed energy generator 118 because taxes and other charges would also have been higher without the distributed energy generator 118. When all costs are considered, the hypothetical utility bill can be computed as:

$1391=($200 of value from the DEG including taxes)+$1191 (12)

$1361=($200*85%)+$1191 (13)

In the above example, the customer saves $30.

It should be noted that in some embodiments, the at least one customer is able to access expert information regarding distributed energy generators tailored to location and personal requirements. For example, the customer could be a laundromat in California. The laundromat could decide to use a solar water heating system to provide greater savings than a solar electric system, due to the water intensive nature of the laundromat industry.

In addition, in some embodiments, information can be gathered relating to distributed energy generator installation that can be useful in tuning for better distributed energy generator performance efficiency and capital efficiency of future installations. For example, the energy output of the distributed energy generator 118 can be compared to the specifications of the distributed energy generator 118, the weather data at the customer's site, and the customer's energy usage to determine an optimal size and type of distributed energy generator for a given type of customer.

Furthermore, in some embodiments, the distributed energy generator 118 can operate at peak performance levels through continuous monitoring of distributed energy generator output. For example, the energy output of the distributed energy generator 118 can be continuously monitored and compared to the ambient weather conditions. If the distributed energy generator 118 is not performing as predicted given the ambient weather conditions, the system can be flagged for maintenance to return the system to peak performance levels.

While various embodiments of the present invention have been described above, it should be understood that they have been presented by way of example, and not limitation. It will be apparent to persons skilled in the relevant art(S) that various changes in form and detail can be made therein without departing from the spirit and scope of the present invention. Thus, the present invention should not be limited by any of the above-described exemplary embodiments.

In addition, it should be understood that the figures described above, which highlight the functionality and advantages of the present invention, are presented for example purposes only. The architecture of the present invention is sufficiently flexible and configurable, such that it may be utilized in ways other than that shown in the figures.

Further, the purpose of the Abstract of the Disclosure is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract of the Disclosure is not intended to be limiting as to the scope of the present invention in any way.

Finally, it is the applicant's intent that only claims that include the express language “means for” or “step for” be interpreted under 35 U.S.C. 112, paragraph 6. Claims that do not expressly include the phrase “means for” or “step for” are not to be interpreted under 35 U.S.C. 112, paragraph 6.

1. A computerized method for monitoring at least one distributed energy generator, comprising:
receiving, by at least one processor over at least one network, utility bill information related to at least one existing utility of at least one customer, and measured energy information from the at least one distributed energy generator of the at least one customer; and
generating at least one bill for measured energy from the at least one distributed energy generator, utilizing the at least one processor, the at least one bill taking into account the utility bill related to the at least one existing utility.

2. The method of claim 1, wherein the generating includes applying a pre-set discount rate to the at least one bill.

3. The method of claim 1, wherein value is provided to the at least one customer immediately after installation of the at least one distributed energy generator.

4. The method of claim 1, wherein the at least one distributed energy generator is provided to the customer without requiring the at least one customer to make a significant capital investment.

5. The method of claim 1, wherein expert information regarding distributed energy generators tailored to at least one location and personal requirements is provided.

6. The method of claim 1, wherein the at least one distributed energy generator is provided to the at least one customer without requiring the at least one customer to risk maintenance costs.

7. The method of claim 1, wherein the at least one distributed energy generator is provided to the at least one customer without requiring the at least one customer to risk distributed energy production being below predicted output.

8. The method of claim 1, wherein efficiency and cost information relating to distributed energy generator products and installation is used to determine which distributed energy generator products to use in the future.

9. The method of claim 1, wherein the at least one distributed energy generator operates at peak performance levels through continuous monitoring of distributed energy generator output.

10. The method of claim 1, wherein value from renewable energy credits delivered by the at least one distributed energy generator is provided to the at least one customer regardless of the at least one customer's size and/or understanding of the renewable energy credit market.

11. The method of claim 1, wherein operational anomalies of the at least one distributed energy generator and the at least one customer's existing equipment are monitored to flag developing problems.

12. The method of claim 1, wherein information is provided to the at least one customer regarding how the at least one customer is using energy from the at least one distributed energy generator.

13. The method of claim 1, wherein information is provided to the at least one customer regarding how the at least one customer is using energy from the at least one customer's existing utility.

14. The method of claim 1, wherein information is provided that can be used to enable more accurate pricing formulas and product and system performance forecasts.

15. The method of claim 1, wherein small non-qualifying distributed energy generators are operated on a larger scale to qualify for benefits.

16. The method of claim 15, wherein the benefits comprise:
tax-related benefits;
clean energy program benefits;
aggregation of RECs or SRECs; or
greentags; or
any combination thereof.

17. The method of claim 1, wherein, at any point in time, the at least one customer is not required to pay more for energy from the at least one distributed energy generator than the at least one customer would have paid for equivalent energy purchased from the customer's existing utility.

18. A computerized system for monitoring at least one distributed energy, generator, comprising:
at least one processor executing at least one billing application, the billing application configured for:
receiving, utility utility bill information related to at least one existing utility of at least one customer, and measured energy information from the at least one distributed energy generator; and
generating at least one bill for measured energy from the at least one distributed energy generator, the at least one bill taking into account the utility bill information related to the at least one existing utility.

19. The system of claim 18, wherein the utility rate information comprises at least one customer's existing utility rate structure.

20. The system of claim 18, wherein system provides the at least one customer with value immediately after installation of the at least one distributed energy generator.

21. The system of claim 18, wherein the system enables the at least one customer to install the at least one distributed energy generator without making a significant capital investment.

22. The system of claim 18, wherein the system provides the at least one customer with expert information regarding distributed energy generators tailored to location and personal requirements.

23. The system of claim 18, wherein the system provides the at least one customer with benefits of the at least one distributed energy generator without risking maintenance costs.

24. The system of claim 18, wherein the system provides the at least one customer with benefits of the at least one distributed energy generator system without risking distributed energy production being below predicted output.

25. The system of claim 18, wherein efficiency and cost information relating to distributed energy generator products and installation is used to determine which generator products to use in the future.

26. The system of claim 18, wherein the system facilitates the at least one distributed energy generator operating at peak performance levels through continuous monitoring of distributed energy generator output.

27. The system of claim 18, wherein the system provides the at least one customer with value from renewable energy credits delivered by the at least one distributed energy generator regardless of the at least one customer's size and/or understanding of the renewable energy credit market.

28. The system of claim 18, wherein the system monitors operational anomalies of the at least one distributed energy generator and the at least one customer's existing equipment to flag developing problems.

29. The system of claim 18, wherein the system provides the at least one customer with information regarding how the at least one customer is using energy from the at least one distributed energy generator.

30. The system of claim 18, wherein the system provides the at least one customer with information regarding how the at least one customer is using energy from the at least on customer's existing utility.

31. The system of claim 18, wherein information is provided that can be used to enable more accurate pricing formulas and product and system performance forecasts.

32. The system of claim 18, wherein the system enables small non-qualifying distributed energy generators to be operated on a larger scale to qualify for benefits.

33. The system of claim 32, wherein the benefits comprise:
tax-related benefits;
clean energy program benefits;
aggregation of RECs or SRECs; or
greentags; or
any combination thereof.

34. The system of claim 18, wherein the system facilitates the at least one customer paying the same amount or a lesser amount for energy from the at least one distributed energy generator than the at least one customer would have paid for equivalent energy purchased from the customer's existing utility.

35. The system of claim 18, wherein the at least one billing application is further configured for receiving: customer information, usage information, weather information, or equipment efficiency information, or any combination thereof.

36. The system of claim 18, wherein the at least one billing application comprises: at least one analytical tool and/or at least one web visual tool.

37. The system of claim 18, wherein the at least one billing application is further configured for:
detecting efficiency of the at least one existing utility and/or the at least one distributed energy generator.

38. The system of claim 37, wherein the efficiency is detected utilizing:
existing utility operation information, input and output temperature; flow rate; or
distributed energy generator information; or any combination thereof.

39. The method of claim 1, further comprising receiving: customer information, usage information, weather information, or equipment efficiency information, or any combination thereof.

40. The method of claim 1, further comprising utilizing at least one analytical tool and/or at least one web visual tool in generating the at least one bill.

41. The method of claim 1, further comprising detecting efficiency of the at least one existing utility and/or the at least one distributed energy generator.

42. The method of claim 41, wherein the efficiency is detected utilizing:
existing utility operation information, input and output temperature; flow rate; or
distributed energy generator information; or any combination thereof.

43. The method of claim 1, wherein the utility bill information comprises utility rate structure information and/or meter register information.

44. The system of claim 18, wherein the utility bill information comprises utility rate structure information and/or meter register information.

45. The method of claim 1, wherein the at least one generated bill comprises utility bill information for more than one existing utility.

46. The system of claim 18, wherein the at least one generated bill comprises utility bill information for at least two existing utilities.

47. The method of claim 1, wherein the at least one generated bill has a cycle at or near the cycle of the at least one existing utility.

48. The system of claim 18, wherein the at least one generated bill has a cycle at or near the cycle of the at least one existing utility.

49. The method of claim 45, wherein the at least two existing utilities have different billing periods.

50. The system of claim 46, wherein the at least two existing utilities have different billing periods.

51. The method of claim 1, wherein at least one virtual meter register mirrors at least one actual utility meter register so that a value of the at least one distributed energy generator can be calculated.

52. The system of claim 18, wherein at least one virtual meter register mirrors at least one actual utility meter register so that a value of the at least one distributed energy generator can be calculated.

53. The method of claim 1, wherein the at least one generated bill accounts for rate changes in the utility bill information over time.

54. The system of claim 18, wherein the at least one generated bill accounts for rate changes in the utility bill information over time.

55. The method of claim 1, wherein the at least one generated bill accounts for efficiency issues of the at least one existing utility.

56. The system of claim 18, wherein the at least one generated bill accounts for efficiency issues of the at least one existing utility.
